(19) United States
(12) Patent Application Publication
(10) Pub. No.: US 2025/0042149 A1
(43) Pub. Date: Feb. 6, 2025

(54) LIQUID EJECTION APPARATUS, LIQUID EJECTION HEAD, AND METHOD OF CONTROLLING LIQUID EJECTION HEAD

(71) Applicant: SEIKO EPSON CORPORATION, Tokyo (JP)

(72) Inventor: Daichi ORIHARA, Shiojiri (JP)

(21) Appl. No.: 18/786,696

(22) Filed: Jul. 29, 2024

(30) Foreign Application Priority Data
Jul. 31, 2023 (JP) 2023-124240

(51) Int. Cl. B41J 2/045

(52) U.S. Cl. CPC B41J 2/0451; B41J 2/04573; B41J 2/04581; B41J 2/04588

(57) ABSTRACT

A liquid ejection head includes an ejection portion ejecting a liquid in response to supply of a drive signal, a supply unit supplying the drive signal to the ejection portion, and a detection unit detecting a vibration in the ejection portion, wherein the supply unit supplies a check drive signal having a check waveform of the drive signal to the ejection portion in a first unit period started by a first latch pulse of latch pulses contained in a latch signal supplied to the supply unit and ended by a second latch pulse provided next to the first latch pulse of the latch pulses, and the detection unit detects a vibration remaining in the ejection portion in a second unit period started by the second latch pulse and ended by a third latch pulse provided next to the second latch pulse of the latch pulses.

The present application is based on, and claims priority from JP Application Serial Number 2023-124240, filed Jul. 31, 2023, the disclosure of which is hereby incorporated by reference herein in its entirety.

### BACKGROUND

### 1. Technical Field

The present disclosure relates to a liquid ejection apparatus, a liquid ejection head, and a method of controlling a liquid ejection head.

### 2. Related Art

A liquid ejection apparatus such as an inkjet printer forms an image on a medium by driving an ejection portion provided in a liquid ejection head in each of a plurality of unit periods defined by a latch signal to eject a liquid such as an ink filled in the ejection portion in each of the plurality of unit periods. However, in the liquid ejection apparatus, an ejection abnormality that the ejection portion fails to normally eject the liquid may occur. Therefore, a technique of checking an ejection state in an ejection portion has been proposed. For example, JP-A-2020-044771 discloses a technique of checking an ejection state of an ejection portion based on a detection signal indicating a vibration remaining in the ejection portion after the ejection portion is driven by a drive signal.

JP-A-2020-044771 is an example of the related art.

However, according to the related art, when the ejection state of the ejection portion is checked, in a unit period as a cycle for driving the ejection portion, it is necessary to set the unit period to a sufficiently long time length in order to execute both the driving of the ejection portion by the drive signal and the detection of the vibration remaining in the driven ejection portion.

### SUMMARY

A liquid ejection head according to an aspect of the present disclosure includes an ejection portion ejecting a liquid in response to supply of a drive signal, a supply unit supplying the drive signal to the ejection portion, and a detection unit detecting a vibration in the ejection portion, wherein the supply unit supplies a check drive signal having a check waveform of the drive signal to the ejection portion in a first unit period started by a first latch pulse of a plurality of latch pulses contained in a latch signal supplied to the supply unit and ended by a second latch pulse provided next to the first latch pulse of the plurality of latch pulses, and the detection unit detects a vibration remaining in the ejection portion in a second unit period started by the second latch pulse and ended by a third latch pulse provided next to the second latch pulse of the plurality of latch pulses.

A liquid ejection apparatus according to an aspect of the present disclosure includes an ejection portion ejecting a liquid in response to supply of a drive signal, a supply unit supplying the drive signal to the ejection portion, and a detection unit detecting a vibration in the ejection portion, wherein the supply unit supplies a check drive signal having a check waveform of the drive signal to the ejection portion in a first unit period started by a first latch pulse of a plurality of latch pulses contained in a latch signal supplied to the supply unit and ended by a second latch pulse provided next to the first latch pulse of the plurality of latch pulses, and the detection unit detects a vibration remaining in the ejection portion in a second unit period started by the second latch pulse and ended by a third latch pulse provided next to the second latch pulse of the plurality of latch pulses.

A method of controlling a liquid ejection head according to an aspect of the present disclosure is a method of controlling a liquid ejection head including an ejection portion ejecting a liquid in response to supply of a drive signal, a supply unit supplying the drive signal to the ejection portion, and a detection unit detecting a vibration in the ejection portion, and the method includes controlling the liquid ejection head to supply a check drive signal having a check waveform of the drive signal to the ejection portion by the supply unit in a first unit period started by a first latch pulse of a plurality of latch pulses contained in a latch signal supplied to the supply unit and ended by a second latch pulse provided next to the first latch pulse of the plurality of latch pulses, and controlling the liquid ejection head to detect a vibration remaining in the ejection portion in a second unit period started by the second latch pulse and ended by a third latch pulse provided next to the second latch pulse of the plurality of latch pulses by the detection unit.

### BRIEF DESCRIPTION OF THE DRAWINGS

FIG. 1 is a block diagram showing an example of a configuration of an inkjet printer 1 according to an embodiment of the present disclosure.

FIG. 2 is a perspective view showing an example of a schematic internal structure of the inkjet printer 1.

FIG. 3 is a cross-sectional view for explanation of an example of a structure of an ejection portion D[m].

FIG. 4 is a block diagram showing an example of a configuration of a head unit 3.

FIG. 5 is a timing chart for explanation of an example of signals supplied to the head unit 3.

FIG. 6 is a block diagram showing an example of a configuration of a coupling state designation circuit 34.

FIG. 7 is an explanatory diagram for explanation of an example of an operation of a decoder DC[m].

FIG. 8 is a timing chart for explanation of an example of a supply drive signal Vin[m].

FIG. 9 is a timing chart for explanation of an example of a detection signal SK[m].

FIG. 10 is an explanatory diagram for explanation of an example of an operation of a check unit 5.

FIG. 11 is a timing chart for explanation of an example of signals supplied to the head unit 3 according to a reference example.

FIG. 12 an explanatory is diagram for explanation of an example of the operation of the decoder DC[m] according to a reference example.

FIG. 13 is a timing chart for explanation of an example of a supply drive signal Vin-W[m] according to a reference example.

FIG. 14 is a block diagram showing an example of a configuration of a head unit 3Z according to Modification 1 of the present disclosure.

FIG. 15 is a timing chart for explanation of an example of signals supplied to the head unit 3Z according to Modification 1.

FIG. 16 is a block diagram showing an example of a configuration of a coupling state designation circuit 34Z according to Modification 1.

FIG. 17 is an explanatory diagram for explanation of an example of an operation of a decoder DCz[m] according to Modification 1.

FIG. 18 is a timing chart for explanation of an example of a supply drive signal Vin-Z[m] according to Modification 1.

### DESCRIPTION OF EMBODIMENTS

As below, embodiments of the present disclosure will be described with reference to the drawings. In the respective drawings, the dimensions and the scales of the respective parts are different from the real ones as appropriate. Further, the following embodiments are preferable specific examples of the present disclosure and various technically preferable limitations are imposed thereon, however, the scope of the present disclosure is not limited to the embodiments unless such limitation is specifically stated in the following description.

### A. Embodiment

In the embodiment, a liquid ejection apparatus will be described using an inkjet printer that ejects an ink to form an image on a recording paper PP as an example.

### 1. Overview of Inkjet Printer

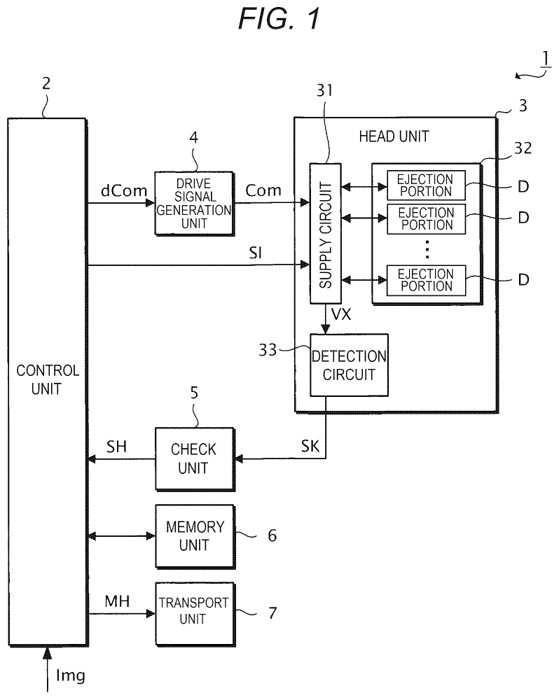

As below, an example of a configuration of an inkjet printer 1 according to the embodiment will be described with reference to FIGS. 1 to 3.

FIG. 1 is a functional block diagram showing an example of the configuration of the inkjet printer 1.

As shown in FIG. 1, print data Img representing an image to be formed by the inkjet printer 1 is supplied to the inkjet printer 1 from a personal computer or a host computer such as a digital camera. The inkjet printer 1 executes printing processing of forming an image represented by the print data Img supplied from the host computer on recording paper PP.

As shown in FIG. 1, the inkjet printer 1 includes a control unit 2 that controls each section of the inkjet printer 1, a head unit 3 provided with ejection portions D that eject an ink, a drive signal generation unit 4 that generates a drive signal Com for driving the ejection portion D, a check unit 5 that checks the ejection states of the ink in the ejection portions D, a memory unit 6 that stores various types of information, and a transport unit 7 for changing the relative position of the recording paper PP with respect to the head unit 3. The inkjet printer 1 is an example of a “liquid ejection apparatus”, the ink is an example of “liquid”, and the head unit 3 is an example of a “liquid ejection head”.

In the embodiment, a case where the inkjet printer 1 includes one or more head units 3, one or more drive signal generation units 4 corresponding to the one or more head units 3 on a one-to-one basis, and one or more check units 5 corresponding to the one or more head units 3 on a one-to-one basis is assumed. Specifically, in the embodiment, it is assumed that the inkjet printer 1 includes four head units 3, four drive signal generation units 4 corresponding to the four head units 3 on a one-to-one basis, and four check units 5 corresponding to the four head units 3 on a one-to-one basis. However, as below, for convenience of description, as shown in FIG. 1, the explanation will be made with a focus on one head unit 3 of the four head units 3, one drive signal generation unit 4 provided to correspond to one head unit 3 of the four drive signal generation units 4, and one check unit 5 provided to correspond to one head unit 3 of the four check units 5.

The control unit 2 includes one or more CPUs (Central Processing Units). However, the control unit 2 may include a programmable logic device such as an FPGA (field-programmable gate array) in place of or in addition to the CPU. The control unit 2 includes a memory. The memory includes one or both of a volatile memory such as a RAM (random access memory) and a nonvolatile memory such as a ROM (read only memory), an EEPROM (electrically erasable programmable read-only memory), and a PROM (programmable ROM).

As will be described in detail below, the control unit 2 generates signals for controlling the operation of each section of the inkjet printer 1 including a designation signal SI and a waveform designation signal dCom.

Here, the waveform designation signal dCom is a digital signal that defines the waveform of the drive signal Com.

The drive signal Com is an analog signal for driving the ejection portion D. In the embodiment, a case where the drive signal Com includes a drive signal Com-A, a drive signal Com-B, and a drive signal Com-C is assumed. In the embodiment, the drive signal Com-B is an example of a “check drive signal”, and the drive signal Com-C is an example of a “detection drive signal”.

The designation signal SI is a digital signal that designates the type of the operation of the ejection portion D. Specifically, the designation signal SI designates the type of operation of the ejection portion D as to whether an ink is ejected from the ejection portion D by designating whether to supply the drive signal Com to the ejection portion D.

When the printing processing is executed, the control unit 2 generates a signal for controlling the head unit 3 including the designation signal SI based on the print data Img. Further, when the printing processing is executed, the control unit 2 generates a signal for controlling the drive signal generation unit 4 including the waveform designation signal dCom. Furthermore, when the printing processing is executed, the control unit 2 generates a signal for controlling the transport unit 7. Thereby, in the printing processing, the control unit 2 controls the transport unit 7 to change the relative position of the recording paper PP with respect to the head unit 3, adjusts the ejection of the ink from the ejection portion D, the ejection timing of the ink, and the like, and controls each section of the inkjet printer 1 to form an image corresponding to the print data Img on the recording paper PP.

As shown in FIG. 1, the head unit 3 includes a supply circuit 31, a recording head 32, and a detection circuit 33. The supply circuit 31 is an example of a “supply unit”, and the detection circuit 33 is an example of a “detection unit”.

The recording head 32 includes M ejection portions D. Here, the value M is a natural number satisfying “M≥1”. Hereinafter, among the M ejection portions D provided in the recording head 32, the m-th ejection portion D may be referred to as an “ejection portion D[m]”. Here, the variable m is a natural number satisfying “1≤m≤M”. Further, hereinafter, when a component element, a signal, or the like of the inkjet printer 1 corresponds to the ejection portion D[m] of the M ejection portions D, a subscript[m] may be added to a sign showing the component element, the signal, or the like.

The supply circuit 31 switches whether to supply the drive signal Com to the ejection portion D[m] based on the designation signal SI. Hereinafter, of the drive signals Com, the drive signal Com supplied to the ejection portion D[m] may be referred to as a supply drive signal Vin[m].

The supply circuit 31 switches whether to supply a detection potential signal VX[m] to the detection circuit 33 based on the designation signal SI. Here, the detection potential signal VX[m] is a signal indicating the potential of an upper electrode Zu[m] provided in a piezoelectric element PZ[m] provided in the ejection portion D[m]. Hereinafter, when the detection potential signal VX[m] is supplied from the ejection portion D[m] to the detection circuit 33, the ejection portion D[m] may be referred to as a check object ejection portion DS. The piezoelectric element PZ[m] and the upper electrode Zu[m] will be described later with reference to FIG. 3.

The detection circuit 33 generates the detection signal SK[m] based on the detection potential signal VX[m] supplied from the ejection portion D[m] as the check object ejection portion DS via the supply circuit 31. Specifically, the detection circuit 33 generates the detection signal SK[m] by amplifying the detection potential signal VX[m] and removing a noise component, for example.

The check unit 5 checks whether the ejection state of the ink in the check object ejection portion DS is normal based on the detection signal SK[m]. In other words, the check unit 5 checks whether an ejection abnormality does not occur in the check object ejection portion DS based on the detection signal SK[m]. Then, the check unit 5 generates check result information SH[m] indicating a result of the check. Here, the check result information SH[m] is information indicating whether an ejection abnormality occurs in the ejection portion D[m] selected as the check object ejection portion DS. Further, the ejection abnormality is a generic term of a state in which a nozzle N provided in the ejection portion D[m] fails to normally eject the ink. For example, the ejection abnormality includes a state in which the ejection portion D[m] fails to eject the ink, a state in which the ejection portion D[m] ejects the ink in an amount different from the ejection amount of the ink defined by the drive signal Com, and a state in which the ejection portion D[m] ejects the ink at a speed different from the ejection speed of the ink defined by the drive signal Com.

Hereinafter, processing of checking the ejection state of the ink in the ejection portion D[m] by driving the ejection portion D[m] as the check object ejection portion DS is referred to as ejection state check processing. Further, hereinafter, processing of driving the ejection portion D[m] as the check object ejection portion DS in the ejection state check processing is referred to as check object drive processing. Furthermore, hereinafter, the ejection portion D[m] as the check object ejection portion DS as an object of the ejection state check processing and an object of the check object drive processing is referred to as a check drive ejection portion DS1.

Hereinafter, of the ejection state check processing, processing of detecting the detection potential signal VX[m] from the ejection portion D[m] driven as the check object ejection portion DS is referred to as residual vibration detection processing. Further, hereinafter, the ejection portion D[m] as the check object ejection portion DS that is an object of the ejection state check processing and an object of the residual vibration detection processing is referred to as a vibration detection ejection portion DS2.

When the check object drive processing is executed, the control unit 2 generates a signal for controlling the head unit 3 including the designation signal SI. When the check object drive processing is executed, the control unit 2 generates a signal for controlling the drive signal generation unit 4 including the waveform designation signal dCom. Thereby, the control unit 2 drives the ejection portion D[m] as the check drive ejection portion DS1 in the check object drive processing.

When the residual vibration detection processing is executed, the control unit 2 generates the designation signal SI and controls the head unit 3 to supply the detection potential signal VX[m] corresponding to the ejection portion D[m] driven as the check drive ejection portion DS1 in the check object drive processing to the detection circuit 33. Further, when the residual vibration detection processing is executed, the control unit 2 generates the designation signal SI and drives the ejection portion D[m] driven as the check drive ejection portion DS1 in the check object drive processing as the vibration detection ejection portion DS2. Furthermore, when the residual vibration detection processing is executed, the detection circuit 33 generates the detection signal SK[m] based on the detection potential signal VX[m] detected from the ejection portion D[m] driven as the vibration detection ejection portion DS2.

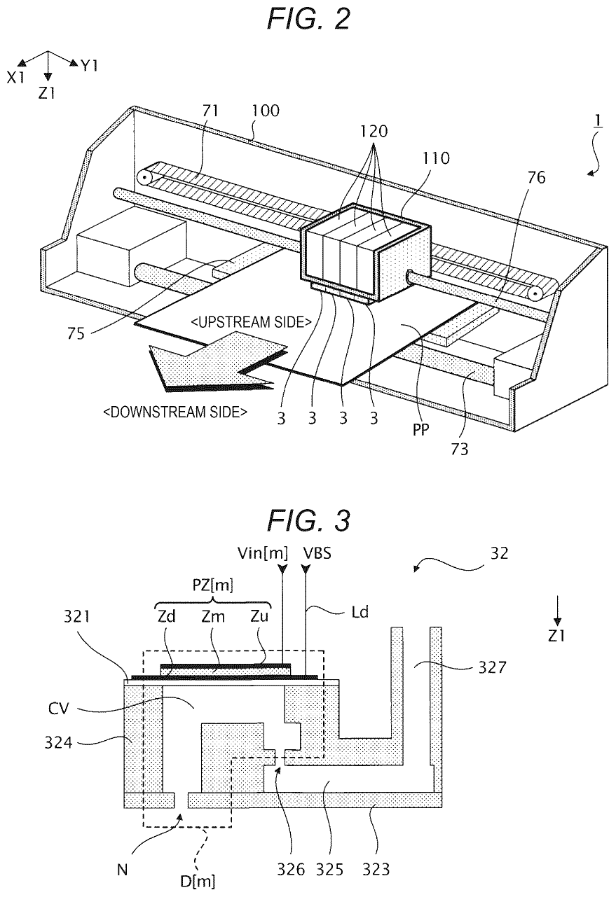

FIG. 2 is a perspective view showing an example of a schematic internal structure of the inkjet printer 1.

As shown in FIG. 2, in the embodiment, a case where the inkjet printer 1 is a serial printer is assumed. Specifically, when executing the printing processing, the inkjet printer 1 forms dots Dt according to the print data Img on the recording paper PP by ejecting the ink from the ejection portions D[m] while transporting the recording paper PP in an X1 direction and reciprocating the head unit 3 in a Y1 direction intersecting the X1 direction and a Y2 direction opposite to the Y1 direction.

Hereinafter, the X1 direction and an X2 direction opposite thereto are collectively referred to as “X-axis direction”, the Y1 direction intersecting the X-axis direction and the Y2 direction opposite thereto are collectively referred to as “Y-axis direction”, and a Z1 direction intersecting the X-axis direction and the Y-axis direction and a Z2 direction opposite thereto are collectively referred to as “Z-axis direction”. In the embodiment, a case where the X-axis direction, the Y-axis direction, and the Z-axis direction are orthogonal to one other will be described as an example. However, the present disclosure is not limited to the configuration. It is only necessary that the X-axis direction, the Y-axis direction, and the Z-axis direction intersect one another. In the embodiment, the Z1 direction is a direction in which the ink is ejected from the ejection portion D[m].

As shown in FIG. 2, the inkjet printer 1 according to the embodiment includes a housing 100 and a carriage 110 that can reciprocate in the Y axis direction within the housing 100 with the four head units 3 mounted thereon.

In the embodiment, as shown in FIG. 2, a case where the carriage 110 holds four ink cartridges 120 corresponding to inks in four colors of cyan, magenta, yellow, and black on a one-to-one basis is assumed. In the embodiment, as described above, a case where the inkjet printer 1 includes the four head units 3 corresponding to the four ink cartridges 120 on a one-to-one basis is assumed. Each ejection portion D[m] is supplied with the ink from the ink cartridge 120 corresponding to the head unit 3 provided with the ejection portion D[m]. Accordingly, each ejection portion D[m] can fill the inside thereof with the supplied ink and eject the ink filled in the ejection portion D[m] from the nozzle N provided in the ejection portion D[m]. The ink cartridge 120 may be provided outside the carriage 110.

As described above, the inkjet printer 1 according to the embodiment includes the transport unit 7. As shown in FIG. 2, the transport unit 7 includes a carriage transport mechanism 71 for reciprocating the carriage 110 in the Y-axis direction, a carriage guide shaft 76 for supporting the carriage 110 to reciprocate in the Y-axis direction, a medium transport mechanism 73 for transporting the recording paper PP, and a platen 75 provided in the Z1 direction of the carriage 110. Accordingly, when the printing processing is executed, the transport unit 7 controls the carriage transport mechanism 71 to reciprocate the head units 3 in the Y-axis direction along the carriage guide shaft 76 together with the carriage 110 and controls the medium transport mechanism 73 to transport the recording paper PP on the platen 75 in the X1 direction to change the relative position of the recording paper PP with respect to the head units 3, and thereby, enables landing of the ink over the entire of the recording paper PP.

FIG. 3 is a schematic partial cross-sectional view of the recording head 32 when the recording head 32 is cut to include the ejection portion D[m].

As shown in FIG. 3, the ejection portion D[m] includes the piezoelectric element PZ[m], a cavity CV filled with the ink, the nozzle N communicating with the cavity CV, and a vibrating plate 321. The ejection portion D[m] ejects the ink inside the cavity CV from the nozzle N by the piezoelectric element PZ[m] being driven by the supply drive signal Vin[m]. The cavity CV is a space defined by a cavity plate 324, a nozzle plate 323 in which the nozzle N is formed, and the vibrating plate 321. The cavity CV communicates with a reservoir 325 via an ink supply port 326. The reservoir 325 communicates with the ink cartridge 120 corresponding to the ejection portion D[m] via an ink intake port 327. The piezoelectric element PZ[m] includes an upper electrode Zu[m], a lower electrode Zd[m], and a piezoelectric material Zm[m] provided between the upper electrode Zu[m] and the lower electrode Zd[m]. The lower electrode Zd[m] is electrically coupled to a feed line Ld set at a predetermined potential VBS. When the supply drive signal Vin[m] is supplied to the upper electrode Zu[m] and a voltage is applied between the upper electrode Zu[m] and the lower electrode Zd[m], the piezoelectric element PZ[m] is displaced in the Z1 direction or the Z2 direction according to the applied voltage, and as a result, the piezoelectric element PZ[m] vibrates. The lower electrode Zd[m] is bonded to the vibrating plate 321. Therefore, when the piezoelectric element PZ[m] is driven by the supply drive signal Vin[m] and vibrates, the vibrating plate 321 also vibrates. Then, the volume of the cavity CV and the pressure in the cavity CV change due to the vibration of the vibrating plate 321, and the ink filled in the cavity CV is ejected from the nozzle N.

### 2. Overview of Head Unit

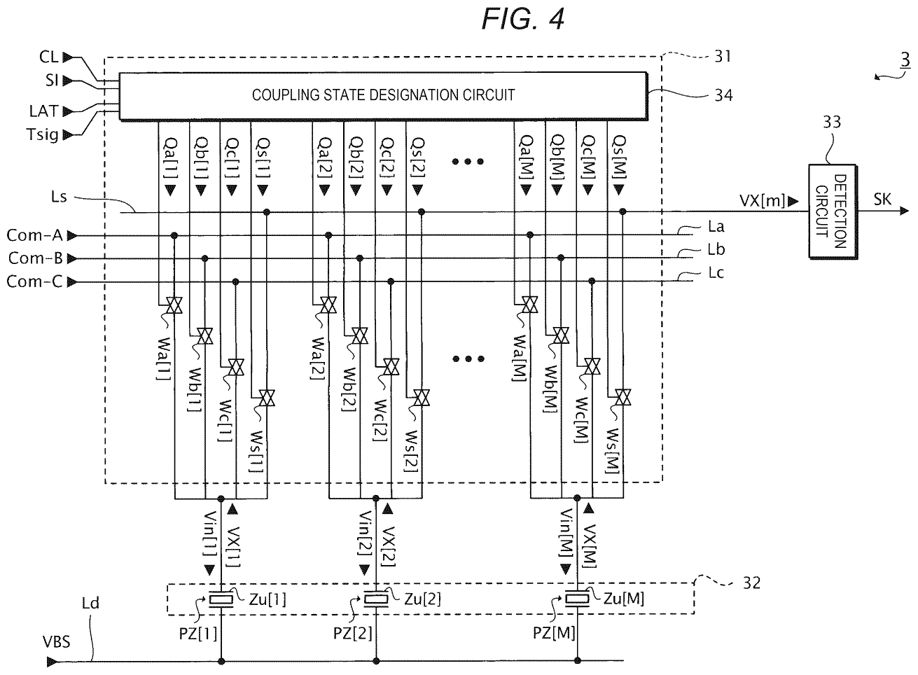

As below, an overview of the head unit 3 will be described with reference to FIGS. 4 to 8.

FIG. 4 is a block diagram showing an example of the configuration of the head unit 3.

As shown in FIG. 4, the head unit 3 includes the supply circuit 31, the recording head 32, and the detection circuit 33. The head unit 3 includes a wire La to which the drive signal Com-A is supplied from the drive signal generation unit 4, a wire Lb to which the drive signal Com-B is supplied from the drive signal generation unit 4, a wire Lc to which the drive signal Com-C is supplied from the drive signal generation unit 4, and a wire Ls for supplying the detection potential signal VX[m] to the detection circuit 33.

The supply circuit 31 includes M switches Wa[1] to Wa[M] corresponding to the M ejection portions D[1] to D[M] on a one-to-one basis, M switches Wb[1] to Wb[M] corresponding to the M ejection portions D[1] to D[M] on a one-to-one basis, M switches Wc[1] to Wc[M] corresponding to the M ejection portions D[1] to D[M] on a one-to-one basis, M switches Ws[1] to Ws[M] corresponding to the M ejection portions D[1] to D[M] on a one-to-one basis, and a coupling state designation circuit 34 for designating a coupling state of each switch.

The coupling state designation circuit 34 generates a coupling state designation signal Qa[m] designating ON/OFF of the switch Wa[m], a coupling state designation signal Qb[m] designating ON/OFF of the switch Wb[m], a coupling state designation signal Qc[m] designating ON/OFF of the switch Wc[m], and a coupling state designation signal Qs[m] designating ON/OFF of the switch Ws[m] based on the designation signal SI, a latch signal LAT, and a period designation signal Tsig supplied from the control unit 2.

The switch Wa[m] switches continuity and discontinuity between the wire La and the upper electrode Zu[m] of the piezoelectric element PZ[m] based on the coupling state designation signal Qa[m]. In the embodiment, the switch Wa[m] is turned on when the coupling state designation signal Qa[m] is at a high level, and turned off when the signal is at a low level. When the switch Wa[m] is turned on, the drive signal Com-A supplied to the wire La is supplied to the upper electrode Zu[m] of the ejection portion D[m] as the supply drive signal Vin[m].

The switch Wb[m] switches continuity and discontinuity between the wire Lb and the upper electrode Zu[m] of the piezoelectric element PZ[m] based on the coupling state designation signal Qb[m]. In the embodiment, the switch Wb[m] is turned on when the coupling state designation signal Qb[m] is at the high level, and turned off when the signal is at the low level. When the switch Wb[m] is turned on, the drive signal Com-B supplied to the wire Lb is supplied to the upper electrode Zu[m] of the ejection portion D[m] as the supply drive signal Vin[m].

The switch Wc[m] switches continuity and discontinuity between the wire Lc and the upper electrode Zu[m] of the piezoelectric element PZ[m] based on the coupling state designation signal Qc[m]. In the embodiment, the switch Wc[m] is turned on when the coupling state designation signal Qc[m] is at the high level, and turned off when the signal is at the low level. When the switch Wc[m] is turned on, the drive signal Com-C supplied to the wire Lc is supplied to the upper electrode Zu[m] of the ejection portion D[m] as the supply drive signal Vin[m].

The switch Ws[m] switches continuity and discontinuity between the wire Ls and the upper electrode Zu[m] of the piezoelectric element PZ[m] based on the coupling state designation signal Qs[m]. In the embodiment, the switch Ws[m] is turned on when the coupling state designation signal Qs[m] is at the high level, and turned off when the signal is at the low level. When the switch Ws[m] is turned on, the potential of the upper electrode Zu[m] provided in the ejection portion D[m] is supplied as the detection potential signal VX[m] to the detection circuit 33 via the wire Ls.

In the embodiment, the detection circuit 33 generates the detection signal SK[m] having a waveform corresponding to the waveform of the detection potential signal VX[m] based on the detection potential signal VX[m] supplied from the wire Ls. Specifically, the detection circuit 33 generates a signal obtained by amplifying the detection potential signal VX[m] and removing a noise component from the detection potential signal VX[m], and outputs the generated signal as the detection signal SK[m].

When the inkjet printer 1 executes the printing processing or the ejection state check processing, a plurality of unit periods TP are set as operating periods of the inkjet printer 1. The inkjet printer 1 can drive each ejection portion D for the printing processing or ejection state check processing in each unit period TP. Note that the k-th unit period TP of the plurality of unit periods TP set as the operating periods of the inkjet printer 1 is referred to as a unit period TP(k). Here, the variable k is a natural number satisfying k≥1.

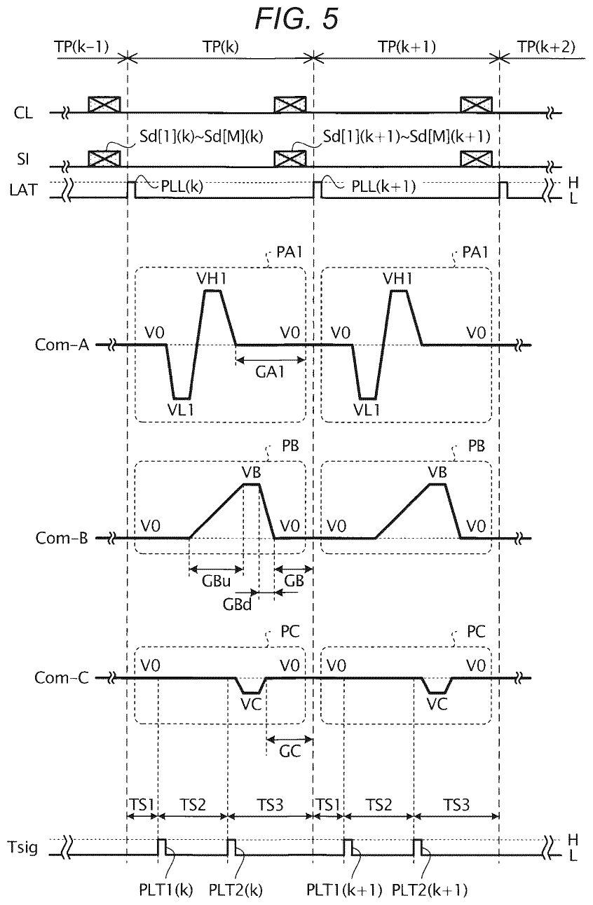

FIG. 5 is a timing chart showing an example of various signals including the drive signal Com supplied to the head unit 3 in the plurality of unit periods TP.

As shown in FIG. 5, the control unit 2 outputs the latch signal LAT having a plurality of pulses PLL. Thereby, the control unit 2 defines the unit period TP as a period from the rise of the pulse PLL to the rise of the next pulse PLL. In the embodiment, the pulse PLL is an example of “latch pulse”.

Hereinafter, the pulse PLL that defines the start of the unit period TP(k) is referred to as a pulse PLL(k). That is, the control unit 2 defines the unit period TP(k) as a period from the rise of the pulse PLL(k) of the latch signal LAT to the rise of the pulse PLL(k+1) of the latch signal LAT, and defines the unit period TP(k+1) as a period from the rise of the pulse PLL(k+1) of the latch signal LAT to the rise of the pulse PLL(k+2) of the latch signal LAT.

The control unit 2 outputs the period designation signal Tsig having the pulse PLT1 and the pulse PLT2 in the unit period TP. The control unit 2 divides the unit period TP into a control period TS1 from the rise of the pulse PLL to the rise of the pulse PLT1, a control period TS2 from the rise of the pulse PLT1 to the rise of the pulse PLT2, and a control period TS3 from the rise of the pulse PLT2 to the rise of the pulse PLL.

Hereinafter, the pulse PLT1 provided in the unit period TP(k) is referred to as a pulse PLT1(k), and the pulse PLT2 provided in the unit period TP(k) is referred to as a pulse PLT2(k).

As shown in FIG. 5, the designation signal SI includes M individual designation signals Sd[1] to Sd[M] corresponding to the M ejection portions D[1] to D[M] on a one-to-one basis. The individual designation signal Sd[m] designates a drive mode of the ejection portion D[m] in each unit period TP when the inkjet printer 1 executes the printing processing or the ejection state check processing. Prior to each unit period TP, the control unit 2 supplies the designation signal SI containing the M individual designation signals Sd[1] to Sd[M] to the coupling state designation circuit 34 in synchronization with a clock signal CL. In the unit period TP, the coupling state designation circuit 34 generates the coupling state designation signal Qa[m], the coupling state designation signal Qb[m], the coupling state designation signal Qc[m], and the coupling state designation signal Qs[m] based on the individual designation signal Sd[m].

In the embodiment, the individual designation signal Sd[m] can take any one of four values of a value “1” designating the ejection portion D[m] as a print ejection portion DP, a value “2” designating the ejection portion D[m] as a dot non-forming ejection portion DN, a value “3” designating the ejection portion D[m] as the check drive ejection portion DS1, and a value “4” designating the ejection portion D[m] as the vibration detection ejection portion DS2 in the unit period TP in which the printing processing or the ejection n state check processing is performed.

Here, the print ejection portion DP is the ejection portion D that ejects the ink from the nozzle N in the unit period TP to form the dot Dt on the recording paper PP. The dot non-forming ejection portion DN is the ejection portion D that does not eject the ink from the nozzle N in the unit period TP and does not form the dot Dt on the recording paper PP. As described above, the check drive ejection portion DS1 is the ejection portion D as the object of the check object drive processing in the unit period TP of the check object ejection portion DS. Further, as described above, the vibration detection ejection portion DS2 is the ejection portion D as the object of the residual vibration detection processing in the unit period TP of the check object ejection portion DS.

As shown in FIG. 5, the drive signal Com-A has a waveform PA1 provided in each unit period TP. Here, the waveform PA1 is a waveform that returns from a reference potential V0 to the reference potential V0 through a potential VL1 lower than the reference potential V0 and a potential VH1 higher than the reference potential V0 in each unit period TP. When the supply drive signal Vin[m] having the waveform PA1 is supplied to the ejection portion D[m], the waveform PA1 is determined such that the ink corresponding to the dot Dt is ejected from the ejection portion D[m].

In the embodiment, as an example, a case where, when the potential of the supply drive signal Vin[m] supplied to the ejection portion D[m] is a high potential, the volume of the cavity CV provided in the ejection portion D[m] is smaller than that when the potential is a low potential: is assumed. Accordingly, when the ejection portion D[m] is driven by the supply drive signal Vin[m] having the waveform PA1, the potential of the supply drive signal Vin[m] changes from the low potential to the high potential, and thereby, the ink in the ejection portion D[m] is ejected from the nozzle N.

Hereinafter, a time length from the end of the waveform PA1 of the drive signal Com-A to the end of the unit period TP in which the waveform PA1 is provided may be referred to as a time length GA1. Specifically, the time length GA1 is a time length from the timing when the potential change from the potential VH1 to the reference potential V0 of the waveform PA1 of the drive signal Com-A is completed to the timing when the unit period TP in which the waveform PA1 is provided ends.

As shown in FIG. 5, the drive signal Com-B has a waveform PB provided in each unit period TP. Here, the waveform PB is a waveform that returns from the reference potential V0 to the reference potential V0 through a potential VB higher than the reference potential V0 in each unit period TP.

In the embodiment, the reference potential V0 is an example of “first potential”, and the potential VB is an example of “second potential”.

Hereinafter, a time length from the end of the waveform PB of the drive signal Com-B to the end of the unit period TP in which the waveform PB is provided may be referred to as a time length GB. Specifically, the time length GB is a time length from a timing when the potential change from the potential VB to the reference potential V0 of the waveform PB of the drive signal Com-B is completed to a timing when the unit period TP in which the waveform PB is provided ends.

Hereinafter, a time length required for the waveform PB of the drive signal Com-B to change from the reference potential V0 to the potential VB is referred to as a time length GBu, and a time length required for the waveform PB of the drive signal Com-B to change from the potential VB to the reference potential V0 is referred to as a time length GBd. In the embodiment, the time length GBu is adjusted so that the ink is not ejected from the ejection portion D[m] even when the ejection portion D[m] is driven by the drive signal Com-B. Specifically, in the embodiment, the waveform PB is provided such that the time length GBu is longer than the time length GBd.

As shown in FIG. 5, the drive signal Com-C is a signal in which the reference potential V0 is maintained in the control period TS1 and the control period TS2 of each unit period TP and the waveform PC is provided in the control period TS3 of each unit period TP. Here, the waveform PC is a waveform that returns from the reference potential V0 to the reference potential V0 through a potential VC lower than the reference potential V0. In the embodiment, the waveform PC is provided so that the ink is not ejected from the ejection portion D[m] even when the ejection portion D[m] is driven by the drive signal Com-C. In the embodiment, since the ejection portion D[m] is driven by the drive signal Com-C having the waveform PC, the ink inside the cavity CV of the ejection portion D[m] is stirred, and an increase in viscosity of the ink inside the ejection portion D[m] can be suppressed.

Hereinafter, a time length from the end of the waveform PC of the drive signal Com-C to the end of the unit period TP in which the waveform PC is provided may be referred to as a time length GC. Specifically, the time length GC is a time length from the timing when the potential change from the potential VC to the reference potential V0 of the waveform PC of the drive signal Com-C is completed to the timing when the unit period TP in which the waveform PC is provided ends.

In the embodiment, the waveform the waveform PB, and the waveform PC are provided such that the time length GB is shorter than the time length GA1 and the time length GB is shorter than the time length GC. That is, in the embodiment, the time length GB from the end of the waveform PB to the end of the unit period TP in which the waveform PB is provided is shorter than the time length GA1 from the end of the waveform PA1 to the end of the unit period TP in which the waveform PA1 is provided, and is shorter than the time length GC from the end of the waveform PC to the end of the unit period TP in which the waveform PC is provided.

Hereinafter, the waveform PA1, the waveform PB, and the waveform PC may be collectively referred to as a “drive waveform”. In the embodiment, the waveform PB is an example of a “check waveform”.

In the embodiment, the case where the drive signal Com-C has the waveform PC is described as an example, but the present disclosure is not limited to the configuration. For example, the drive signal Com-C may be a signal in which the reference potential V0 is maintained over each unit period TP.

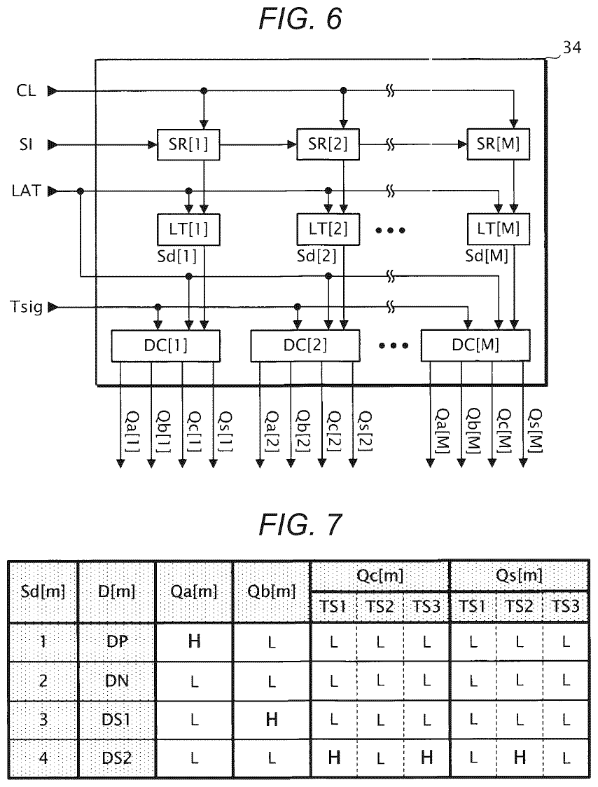

FIG. 6 is a block diagram showing an example of a configuration of the coupling state designation circuit 34.

As shown in FIG. 6, the coupling state designation circuit 34 includes M transfer circuits SR[1] to SR[M] provided to correspond to the M ejection portions D[1] to D[M] on a one-to-one basis, M latch circuits LT[1] to LT[M] provided to correspond to the M ejection portions D[1] to D[M] on a one-to-one basis, and M decoders DC[1] to DC[M] provided to correspond to the M ejection portions D[1] to D[M] on a one-to-one basis. The individual designation signals Sd[1] to Sd[M] are serially supplied to the transfer circuit SR[1]. Then, the individual designation signal Sd[m] supplied to the transfer circuit SR[1] is sequentially transferred from the transfer circuit SR[1] to the transfer circuit SR[m] by the m transfer circuits SR[1] to SR[m] of the M transfer circuits SR[1] to SR[M] in synchronization with the clock signal CL. The latch circuit LT[m] latches the individual designation signal Sd[m] supplied to the transfer circuit SR[m] at timing when the pulse PLL of the latch signal LAT rises to a high level. The decoder DC[m] generates the coupling state designation signal Qa[m], the coupling state designation signal Qb[m], the coupling state designation signal Qc[m], and the coupling state designation signal Qs[m] based on the individual designation signal Sd[m], the latch signal LAT, and the period designation signal Tsig.

FIG. 7 is an explanatory diagram showing an example of an operation of the decoder DC[m].

As shown in FIG. 7, when the individual designation signal Sd[m] indicates the value “1” that designates the ejection portion D[m] as the print ejection portion DP in the unit period TP, the decoder DC[m] sets the coupling state designation signal Qa[m] at the high level over the unit period TP. In this case, the switch Wa[m] is turned on for the unit period TP. Accordingly, the ejection portion D[m] is driven by the supply drive signal Vin[m] having the waveform PAL in the unit period TP, and ejects an amount of the ink corresponding to the dot Dt.

When the individual designation signal Sd[m] indicates the value “2” that designates the ejection portion D[m] as the dot non-forming ejection portion DN in the unit period TP, the decoder DC[m] sets the coupling state designation signal Qa[m], the coupling state designation signal Qb[m], the coupling state designation signal Qc[m], and the coupling state designation signal Qs[m] at the low level over the unit period TP. In this case, the switch Wa[m], the switch Wb[m], the switch Wc[m], and the switch Ws[m] are turned off for the unit period TP. Accordingly, the ejection portion D[m] is not driven by the supply drive signal Vin[m] in the unit period TP, and does not eject the ink.

When the individual designation signal Sd[m] indicates the value “3” that designates the ejection portion D[m] as the check drive ejection portion DS1 in the unit period TP, the decoder DC[m] sets the coupling state designation signal Qb[m] at the high level over the unit period TP. In this case, the switch Wb[m] is turned on for the unit period TP. Accordingly, in the unit period TP, the ejection portion D[m] is driven by the supply drive signal Vin[m] having the waveform PB, and a vibration is generated in the ejection portion D[m].

When the individual designation signal Sd[m] indicates the value “4” that designates the ejection portion D[m] as the vibration detection ejection portion DS2 in the unit period TP, the decoder DC[m] sets the coupling state designation signal Qc[m] to the high level in the control period TS1 and the control period TS3, and sets the coupling state designation signal Qs[m] at the high level in the control period TS2. In this case, the switch Wc[m] is turned on in the control period TS1 and the control period TS3, and the switch Ws[m] is turned on in the control period TS2. Accordingly, when a vibration remains in the ejection portion D[m] in the control period TS2, the detection circuit 33 detects the potential of the upper electrode Zu[m], which changes according to the vibration remaining in the ejection portion D[m] in the control period TS2, as the detection potential signal VX[m] via the switch Ws[m].

The waveform of the detection potential signal VX[m] detected from the ejection portion D[m] in the control period TS2 indicates the waveform of the vibration remaining in the ejection portion D[m] in the control period TS2. The waveform of the detection signal SK[m] generated based on the detection potential signal VX[m] detected from the ejection portion D[m] in the control period TS2 indicates the waveform of the vibration remaining in the ejection portion D[m] in the control period TS2.

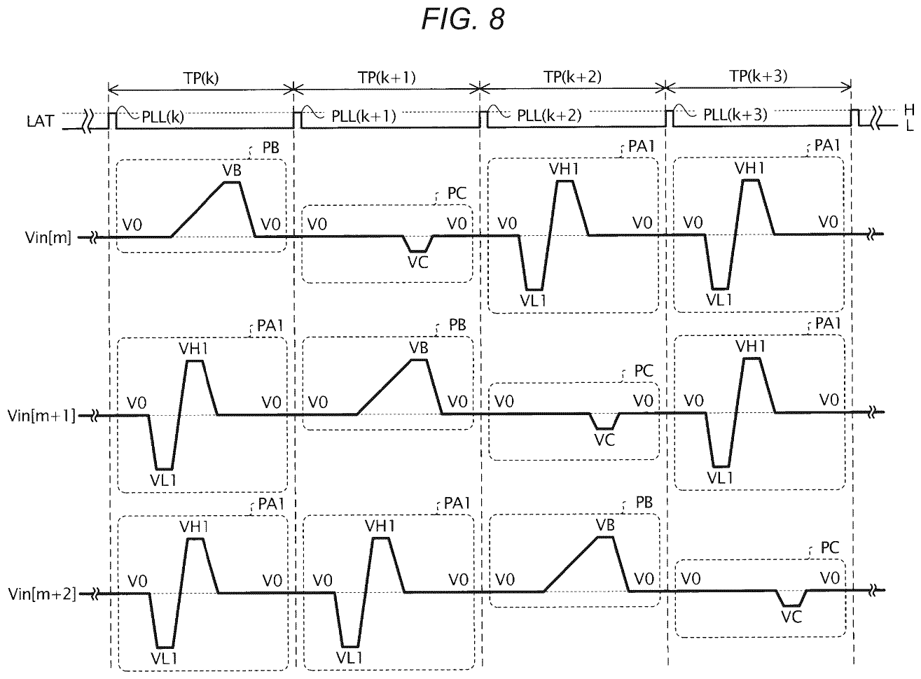

FIG. 8 is a timing chart showing an example of the plurality of supply drive signals Vin[m] to Vin[m+2] supplied to the plurality of ejection portions D[m] to D[m+2] provided in the head unit 3 in the plurality of unit periods TP(k) to TP(k+3).

In FIG. 8, a case where the variable m is a natural number satisfying “1≤m≤M−2” is assumed. Hereinafter, the supply drive signal Vin[m] supplied to the ejection portion D[m] in the unit period TP(k) is referred to as a supply drive signal Vin[m](k). Further, hereinafter, the individual designation signal Sd[m] designating the operation of the ejection portion D[m] in the unit period TP(k) is referred to as an individual designation signal Sd[m](k).

In FIG. 8, a case where the inkjet printer 1 executes the ejection state check processing three times for the three ejection portions D of the ejection portion D[m], the ejection portion D[m+1], and the ejection portion D[m+2] in the four unit periods TP of the unit period TP(k), the unit period TP(k+1), the unit period TP(k+2), and the unit period TP(k+3) is assumed. Further, in FIG. 8, a case where the inkjet printer 1 drives the ejection portion D which is not an object of the ejection state check processing of the three ejection portions D of the ejection portion D[m], the ejection portion D[m+1], and the ejection portion D[m+2] as the print ejection portion DP is assumed.

In the embodiment, when executing the ejection state check processing for the ejection portion D[m], the inkjet printer 1 first executes the check object drive processing for the ejection portion D[m] in one unit period TP, and then, executes the residual vibration detection processing for the ejection portion D[m] in another unit period TP subsequent to the one unit period TP.

Specifically, the control unit 2 generates the individual designation signal Sd[m](k) designating the ejection portion D[m] as the check drive ejection portion DS1 in the unit period TP(k), and generates the individual designation signal Sd[m](k+1) designating the ejection portion D[m] as the vibration detection ejection portion DS2 in the unit period TP(k+1). Thereby, as shown in FIG. 8, the inkjet printer 1 supplies the drive signal Com-B having the waveform PB as the supply drive signal Vin[m](k) to the ejection portion D[m] in the unit period TP(k), and supplies the drive signal Com-C having the waveform PC as the supply drive signal Vin[m](k+1) to the ejection portion D[m] in the unit period TP(k+1). As a result, the inkjet printer 1 executes the check object drive processing for the ejection portion D[m] in the unit period TP(k), and then, executes the residual vibration detection processing for the ejection portion D[m] in the unit period TP(k+1).

In this case, the ejection portion D[m] is driven by the drive signal Com-B having the waveform PB and vibrates in a unit period TP(k) which is started by the pulse PLL(k) and ended by the pulse PLL(k+1). Then, the detection circuit 33 detects the vibration generated in the ejection portion D[m] in the unit period TP(k) by the driving by the drive signal Com-B and remaining in the ejection portion D[m] in the unit period TP(k+1) in the control period TS2 of the unit period TP(k+1), and generates the detection signal SK[m] based on the detection potential signal VX[m] indicating the detection result. In the above described manner, the inkjet printer 1 executes the ejection state check processing on the ejection portion D[m].

In FIG. 8, the inkjet printer 1 supplies the drive signal Com-B having the waveform PB as the supply drive signal Vin[m+1](k+1) to the ejection portion D[m+1], and supplies the drive signal Com-C having the waveform PC as the supply drive signal Vin[m+1](k+2) to the ejection portion D[m+1]. Thereby, the inkjet printer 1 executes the ejection state check processing on the ejection portion D[m+1] by executing the check object drive processing for the ejection portion D[m+1] in the unit period TP(k+1), and then, executing the residual vibration detection processing for the ejection portion D[m+1] in the unit period TP(k+2).

Further, the inkjet printer 1 supplies the drive signal Com-B having the waveform PB as the supply drive signal Vin[m+2](k+2) to the ejection portion D[m+2], and supplies the drive signal Com-C having the waveform PC as the supply drive signal Vin[m+2](k+3) to the ejection portion D[m+2]. Thereby, the inkjet printer 1 executes the ejection state check processing on the ejection portion D[m+2] by executing the check object drive processing for the ejection portion D[m+2] in the unit period TP(k+2), and then, executing the residual vibration detection processing for the ejection portion D[m+2] in the unit period TP(k+3).

In the embodiment, the unit period TP(k) is an example of a “first unit period”, and the unit period TP(k+1) is an example of a “second unit period”. In the embodiment, the pulse PLL(k) is an example of “first latch pulse”, the pulse PLL(k+1) is an example of “second latch pulse”, and the pulse PLL(k+2) is an example of “third latch pulse”. In the embodiment, the pulse PLT1(k+1) is an example of “detection start pulse”, the pulse PLT2(k+1) is an example of “detection end pulse”, and the control period TS2 contained in the unit period TP(k+1) is an example of a “detection period”.

### 3. Check Unit

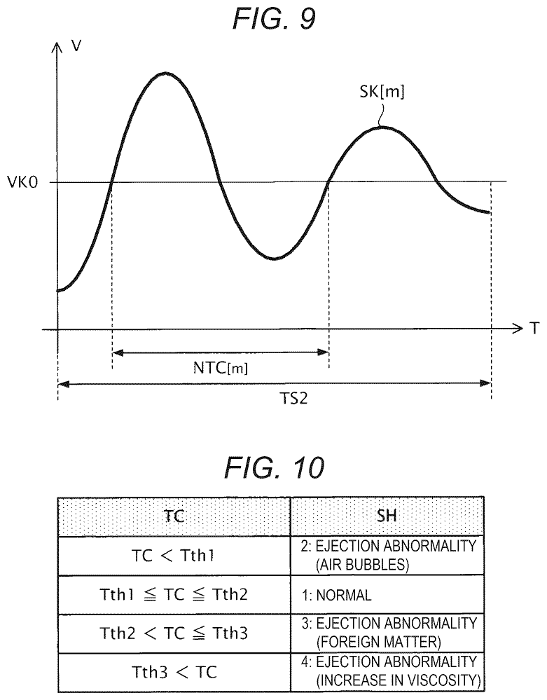

As below, an overview of the check unit 5 will be described with reference to FIGS. 9 and 10.

As described above, the check unit 5 checks the ejection state of the ink in the ejection portion D[m] designated as the check object ejection portion DS based on the detection signal SK[m] supplied from the detection circuit 33.

FIG. 9 is a timing chart for explanation of an example of the detection signal SK[m] supplied to the check unit 5 by the detection circuit 33. The detection signal SK[m] output by the detection circuit 33 in the control period TS2 indicates a waveform based on the vibration remaining in the ejection portion D[m] in the control period TS2.

As shown in FIG. 9, hereinafter, a period from a timing when the potential of the detection signal SK[m] coincides with a center potential VK0 set around the amplitude center of the detection signal SK[m] to the next timing when the potential coincides with the center potential VK0 is referred to as a cycle period NTC[m]. Further, hereinafter, the time length of the cycle period NTC[m] is referred to as a cycle TC[m].

In the embodiment, the check unit 5 measures the cycle TC[m] of the detection signal SK[m]. Then, the check unit 5 checks the ejection state of the ink in the ejection portion D[m] based on the cycle TC[m], and generates check result information SH[m] indicating the result of the check.

FIG. 10 is an explanatory diagram for explanation of an example of generation of the check result information SH[m] in the check unit 5.

As shown in FIG. 10, the check unit 5 compares the cycle TC[m] with part or all of a threshold Tth1, a threshold Tth2, and a threshold Tth3 to check the ejection state of the ink in the ejection portion D[m], and generates check result information SH[m] indicating the result of the check.

The threshold Tth1 is a fixed value for indicating a boundary between the cycle TC[m] of the residual vibration generated in the ejection portion D[m] when the ejection state of the ejection portion D[m] is normal and the cycle TC[m] of the residual vibration generated in the ejection portion D[m] when air bubbles are mixed in the cavity CV of the ejection portion D[m].

The threshold Tth2 is a value larger than the threshold Tth1, and is a fixed value for indicating a boundary between the cycle TC[m] of the residual vibration generated in the ejection portion D[m] when the ejection state of the ejection portion D[m] is normal and the cycle TC[m] of the residual vibration generated in the ejection portion D[m] when foreign matter adheres to the vicinity of the nozzle N of the ejection portion D[m].

The threshold value Tth3 is a value larger than the threshold value Tth2, and is a fixed value for indicating a boundary between the cycle TC[m] of the residual vibration generated in the ejection portion D[m] when foreign matter adheres to the vicinity of the nozzle N of the ejection portion D[m] and the cycle TC[m] of the residual vibration generated in the ejection portion D[m] when the ink in the cavity CV of the ejection portion D[m] increases in viscosity.

In the embodiment, when the cycle TC[m] satisfies “Tth1≤TC[m]≤Tth2”, the check unit 5 determines that the ejection state of the ink in the ejection portion D[m] is normal, and sets a value “1” indicating that the ejection state of the ink in the ejection portion D[m] is normal for the check result information SH[m].

When the cycle TC[m] satisfies “TC[m]<Tth1”, the check unit 5 determines that an ejection abnormality due to the air bubbles occurs in the ejection portion D[m], and sets a value “2” indicating that the ejection abnormality due to the air bubbles occurs in the ejection portion D[m] for the check result information SH[m].

When the cycle TC[m] satisfies “Tth2<TC[m]≤Tth3”, the check unit 5 determines that an ejection abnormality due to the adhesion of foreign matter occurs in the ejection portion D[m], and sets a value “3” indicating that the ejection abnormality due to the adhesion of foreign matter occurs in the ejection portion D[m] for the check result information SH[m].

When the cycle TC[m] satisfies “Tth3<TC[m]”, the check unit 5 determines that an ejection abnormality due to the increase in viscosity occurs in the ejection portion D[m], and sets a value “4” indicating that the ejection abnormality due to the increase in viscosity occurs in the ejection portion D[m] for the check result information SH[m].

### 4. Reference Example

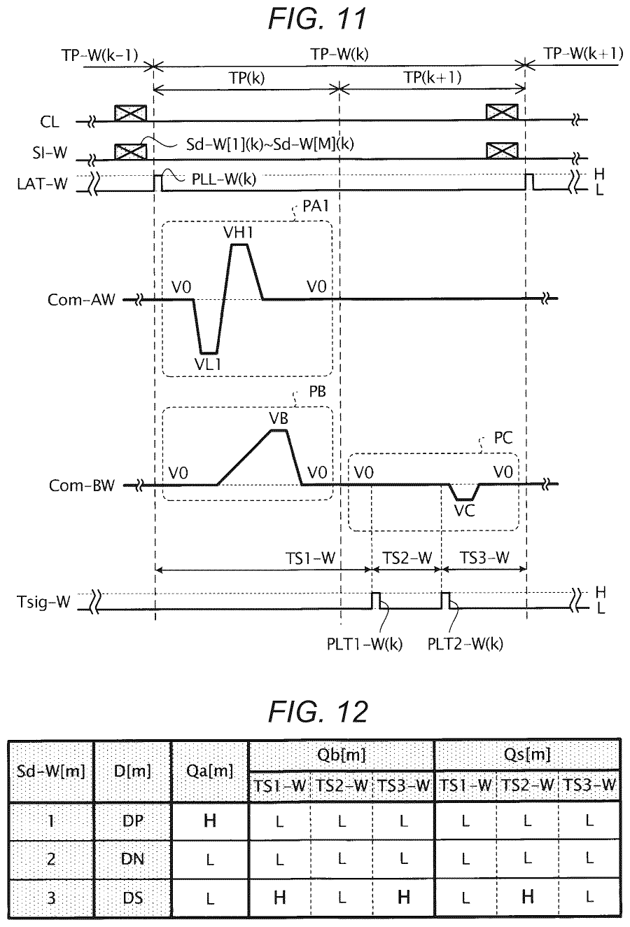

As below, a reference example will be described with reference to FIGS. 11 to 13.

FIG. 11 is a timing chart showing an example of various signals supplied to the head unit 3 in the reference example.

As shown in FIG. 11, the reference example is different from the above described embodiment in that a drive signal Com-W is supplied to the head unit 3 instead of the drive signal Com, a latch signal LAT-W is supplied instead of the latch signal LAT, a designation signal SI-W is supplied instead of the designation signal SI, and a period designation signal Tsig-W is supplied instead of the period designation signal Tsig. The reference example is different from the above described embodiment in that the operating period of the inkjet printer 1 is divided into a plurality of unit periods TP-W. In the reference example, the drive signal Com-W supplied to the ejection portion D[m] is referred to as a supply drive signal Vin-W[m].

In the reference example, the latch signal LAT-W contains a plurality of pulses PLL-W. Accordingly, the control unit 2 according to the reference example defines the unit period TP-W as a period from the rise of the pulse PLL-W to the rise of the next pulse PLL-W.

Hereinafter, the k-th unit period TP-W in the operating period of the inkjet printer 1 according to the reference example is referred to as a unit period TP-W(k). Further, hereinafter, of the plurality of pulses PLL-W contained in the latch signal LAT-W, the pulse PLL-W that defines the start of the unit period TP-W(k) is referred to as a pulse PLL-W(k). Furthermore, hereinafter, the supply drive signal Vin-W[m] supplied to the ejection portion D[m] in the unit period TP-W(k) is referred to as a supply drive signal Vin-W[m](k).

In the reference example, the period designation signal Tsig-W has a pulse PLT1-W and a pulse PLT2-W. Accordingly, the control unit 2 according to the reference example divides the unit period TP-W into a control period TS1-W from the rise of the pulse PLL-W to the rise of the pulse PLT1-W, a control period TS2-W from the rise of the pulse PLT1-W to the rise of the pulse PLT2-W, and a control period TS3-W from the rise of the pulse PLT2-W to the rise of the pulse PLL-W.

Hereinafter, the pulse PLT1-W provided in the unit period TP-W(k) is referred to as a pulse PLT1-W(k), and the pulse PLT2-W provided in the unit period TP-W(k) is referred to as a pulse PLT2-W(k).

In the reference example, the drive signal Com-W includes a drive signal Com-AW and a drive signal Com-BW.

Of the signals, the drive signal Com-AW is a signal in which the waveform PA1 is provided in each unit period TP-W. The drive signal Com-BW is a signal in which the waveform PB is provided in the control period TS1-W of each unit period TP-W, the reference potential V0 is maintained in the control period TS2-W of each unit period TP-W, and the waveform PC is provided in the control period TS3-W of each unit period TP-W.

The control unit 2 according to the reference example supplies the designation signal SI-W to the coupling state designation circuit 34 in synchronization with the clock signal CL prior to each unit period TP-W. Here, the designation signal SI-W includes M individual designation signals Sd-W[1] to Sd-W[M] corresponding to the M ejection portions D[1] to D[M] on a one-to-one basis. Of the signals, the individual designation signal Sd-W[m] designates a drive mode of the ejection portion D[m] in the unit period TP-W. Specifically, the individual designation signal Sd-W[m] can take any one of three values of a value “1” designating the ejection portion D[m] as the print ejection portion DP, a value “2” designating the ejection portion D[m] as the dot non-forming ejection portion DN, and a value “3” designating the ejection portion D[m] as the check object ejection portion DS.

FIG. 12 is an explanatory diagram showing an example of an operation of the decoder DC[m] according to the reference example.

As shown in FIG. 12, when the individual designation signal Sd-W[m] indicates the value “1” that designates the ejection portion D[m] as the print ejection portion DP in the unit period TP-W, the decoder DC[m] according to the reference example sets the coupling state designation signal Qa[m] at the high level over the unit period TP-W as in the above described embodiment.

When the individual designation signal Sd-W[m] indicates the value “2” that designates the ejection portion D[m] as the dot non-forming ejection portion DN in the unit period TP-W, the decoder DC[m] according to the reference example sets the coupling state designation signal Qa[m], the coupling state designation signal Qb[m], the coupling state designation signal Qc[m], and the coupling state designation signal Qs[m] at the low level over the unit period TP-W as in the above described embodiment.

When the individual designation signal Sd-W[m] indicates the value “3” that designates the ejection portion D[m] as the check object ejection portion DS in the unit period TP-W, the decoder DC[m] according to the reference example sets the coupling state designation signal Qb[m] at the high level in the control period TS1-W and the control period TS3-W of the unit period TP-W, and sets the coupling state designation signal Qs[m] at the high level in the control period TS2-W of the unit period TP-W. In this case, the switch Wb[m] is turned on in the control period TS1-W and the control period TS3-W of the unit period TP-W, and the switch Ws[m] is turned on in the control period TS2-W of the unit period TP-W. Accordingly, as a result of the ejection portion D[m] designated as the check object ejection portion DS being driven by the supply drive signal Vin-W[m] having the waveform PB in the control period TS1-W, the vibration generated in the ejection portion D[m] remains even in the control period TS2-W. When the vibration remains in the ejection portion D[m] during the control period TS2-W, the potential of the upper electrode Zu[m] provided in the ejection portion D[m] changes. Then, the detection circuit 33 detects the potential of the upper electrode Zu[m] that changes according to the vibration remaining in the ejection portion D[m] in the control period TS2-W as the detection potential signal VX[m] via the switch Ws[m].

As described above, in the reference example, in the control period TS1-W of the unit period TP-W, the check object drive processing of driving the check object ejection portion DS as the check drive ejection portion DS1 is executed, and in the control period TS2-W of the unit period TP-W, the residual vibration detection processing of driving the check object ejection portion DS as the vibration detection ejection portion DS2 is executed. Accordingly, in the reference example, the unit period TP-W requires at least a total time length of a time for driving the check drive ejection portion DS1 according to the waveform PB and a time for detecting the detection potential signal VX[m] from the vibration detection ejection portion DS2. On the other hand, the unit period TP according to the embodiment is a period requiring only one of the time for driving the check drive ejection portion DS1 according to the waveform PB and the time for detecting the detection potential signal VX[m] from the vibration detection ejection portion DS2. Accordingly, the unit period TP-W according to the reference example has a longer time length than the unit period TP according to the embodiment. In the reference example, as an example, a case where the unit period TP-W has a time length twice as long as the unit period TP is assumed.

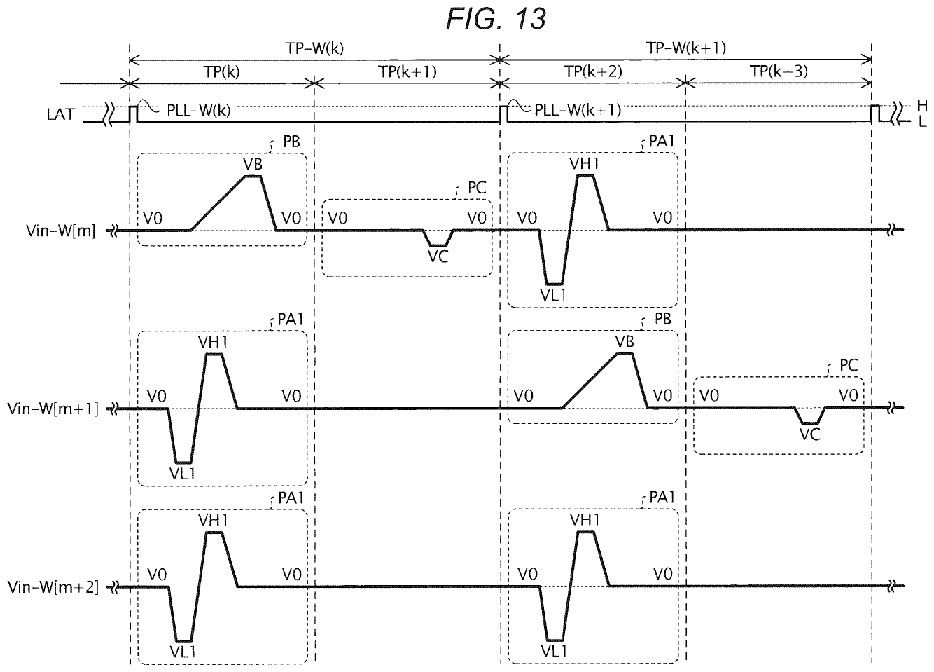

FIG. 13 is a timing chart showing an example of the supply drive signals Vin-W[m] to Vin-W[m+2] supplied to the plurality of ejection portions D[m] to D[m+2] provided in the head unit 3 according to the reference example in the plurality of unit periods TP-W(k) to TP-W(k+1).

In FIG. 13, a case where the variable m is a natural number satisfying “1≤m≤M−2” is assumed. Hereinafter, the individual designation signal Sd-W[m] designating the operation of the ejection portion D[m] in the unit period TP-W(k) is referred to as an individual designation signal Sd-W[m](k).

In FIG. 13, a case where the inkjet printer 1 according to the reference example executes the ejection state check processing at twice for two ejection portions D of the ejection portion D[m] and the ejection portion D[m+1] in two unit periods TP-W of the unit period TP-W(k) and the unit period TP-W(k+1) is assumed. In FIG. 13, a case where the unit period TP-W(k) includes the unit period TP(k) and the unit period TP(k+1), and the unit period TP-W(k+1) includes the unit period TP(k+2) and the unit period TP(k+3) is assumed.

In FIG. 13, a case where the inkjet printer 1 according to the reference example drives the ejection portion D that is not an object of the ejection state check processing of the three ejection portions D of the ejection portion D[m], the ejection portion D[m+1], and the ejection portion D[m+2] as the print ejection portion DP is assumed.

As shown in FIG. 13, the control unit 2 according to the reference example generates the individual designation signal Sd-W[m](k) designating the ejection portion D[m] as the check object ejection portion DS in the unit period TP-W(k). Thereby, the inkjet printer 1 according to the reference example executes the ejection state check processing for the ejection portion D[m] in the unit period TP-W(k).

Further, the control unit 2 according to the reference example generates the individual designation signal Sd-W[m+1](k+1) that designates the ejection portion D[m+1] as the check object ejection portion DS in the unit period TP-W(k+1). Thereby, the inkjet printer 1 according to the reference example executes the ejection state check processing for the ejection portion D[m+1] in the unit period TP-W(k+1).

As described above, according to the reference example, when the ejection state check processing for one ejection portion D is executed in one unit period TP-W, the execution of the ejection state check processing for another ejection portion D is disabled in the one unit period TP-W. Therefore, according to the reference example, the ejection state check processing is executed twice in two unit periods of the unit period TP-W(k) and the unit period TP-W(k+1) corresponding to the period from the unit period TP(k) to the unit period TP(k+3).

On the other hand, in the above described embodiment, when the check object drive processing for one ejection portion D is executed in one unit period TP, the execution of the residual vibration detection processing for another ejection portion D is enabled in the one unit period TP. Therefore, in the above described embodiment, the ejection state check processing is executed three times in the period from the unit period TP(k) to the unit period TP(k+3). That is, according to the embodiment, compared to the reference example, when the ejection state check processing at the plurality of times for the plurality of ejection portions D are executed, the time required for the ejection state check processing at the plurality of times can be shortened.

As shown in FIG. 13, the control unit 2 according to the reference example generates the individual designation signal Sd-W[m+1](k) designating the ejection portion D[m+1] as the print ejection portion DP and the individual designation signal Sd-W[m+2](k) designating the ejection portion D[m+2] as the print ejection portion DP in the unit period TP-W(k). Thereby, the inkjet printer 1 according to the reference example forms two dots Dt by the ejection portion D[m+1] and the ejection portion D[m+2] in the unit period TP-W(k).

Further, the control unit 2 according to the reference example generates the individual designation signal Sd-W[m](k+1) designating the ejection portion D[m] as the print ejection portion DP and the individual designation signal Sd-W[m+2](k+1) designating the ejection portion D[m+2] as the print ejection portion DP in the unit period TP-W(k+1). Thereby, the inkjet printer 1 according to the reference example forms two dots Dt by the ejection portion D[m] and the ejection portion D[m+2] in the unit period TP-W(k+1).

As described above, according to the reference example, as shown in FIG. 13, in the unit period TP-W(k) and the unit period TP-W(k+1) corresponding to the period from the unit period TP(k) to the unit period TP(k+3), four dots Dt are formed by the three ejection portions D[m] to D[m+2]. On the other hand, in the above described embodiment, as shown in FIG. 8, six dots Dt are formed in a period from the unit period TP(k) to the unit period TP(k+3). Therefore, according to the embodiment, compared to the reference example, the time required for forming the desired number of dots Dt may be shortened, and the printing processing may be made faster.

### 5. Conclusion of Embodiment

As described above, the inkjet printer 1 according to the embodiment includes the ejection portion D[m] ejecting the ink in response to the supply of the drive signal Com, the supply circuit 31 supplying the drive signal Com to the ejection portion D[m], and the detection circuit 33 detecting the vibration in the ejection portion D[m]. The supply circuit 31 supplies the drive signal Com-B having the waveform PB of the drive signal Com to the ejection portion D[m] in the unit period TP(k) started by the pulse PLL(k) of the plurality of pulses PLL contained in the latch signal LAT supplied to the supply circuit 31 and ended by the pulse PLL(k+1) provided next to the pulse PLL(k) of the plurality of pulses PLL, and the detection circuit 33 detects the vibration remaining in the ejection portion D[m] in the unit period TP(k+1) started by the pulse PLL(k+1) and ended by the pulse PLL(k+2) provided next to the pulse PLL(k+1) of the plurality of pulses PLL.

As described above, according to the embodiment, the ejection portion D[m] is driven in one unit period TP, and the vibration is detected from the ejection portion D[m] in another unit period TP subsequent to the one unit period TP. Therefore, the time length of the unit period TP can be shortened compared to a configuration in which both driving of the ejection portion D[m] and detection of the vibration from the ejection portion D[m] are performed in the one unit period TP. Thereby, according to the embodiment, the printing processing of forming an image on the recording paper PP by ejecting ink from the ejection portion D[m] can be made faster.

In the inkjet printer 1 according to the embodiment, the supply circuit 31 is supplied with the designation signal SI that designates whether to eject the ink from the ejection portion D[m] in each of the plurality of unit periods TP at the timing corresponding to each of the plurality of unit periods TP defined by the plurality of pulses PLL, and the supply circuit 31 supplies the drive signal Com to the ejection portion D[m] based on the designation signal SI in each of the plurality of unit periods TP.

In the inkjet printer: 1 according to the embodiment, the detection circuit 33 detects the vibration remaining in the ejection portion D[m] in the control period TS2 started by the pulse PLT1(k+1) contained in the period designation signal Tsig supplied to the supply circuit 31 and ended by the pulse PLT2(k+1) contained in the period designation signal Tsig in the unit period TP(k+1).

In the inkjet printer 1 according to the embodiment, the drive signal Com includes the drive signal Com-C supplied to the ejection portion D[m] in at least a part of the unit period TP(k+1), the drive signal Com-B indicates the reference potential V0 at the timing when the pulse PLL(k+1) is supplied to the supply circuit 31, and the drive signal Com-C maintains the reference potential V0 at least in the control period TS1 from the timing when the pulse PLL(k+1) is supplied to the supply circuit 31 to the timing when the control period TS2 is started in the unit period TP(k+1).

Therefore, according to the embodiment, the signal supplied to the ejection portion D[m] can be switched from the drive signal Com-B to the drive signal Com-C at the timing when the unit period TP(k+1) is started. Thereby, according to the embodiment, the drive signal Com-B can be supplied to the ejection portion D[m] for driving the ejection portion D[m] in the unit period TP(k), and the drive signal Com-C can be supplied to the ejection portion D[m] for detecting the vibration from the ejection portion D[m] in the unit period TP(k+1).

In the inkjet printer 1 according to the embodiment, the waveform PB is a waveform that changes from the reference potential V0 to the potential VB and then changes from the potential VB to the reference potential V0.

In the inkjet printer 1 according to the embodiment, the ejection portion D[m] includes the piezoelectric element PZ[m] driven by the drive signal Com, the cavity CV filled with the ink and having the volume that changes according to the driving of the piezoelectric element PZ[m], and the nozzle N ejecting the ink in the cavity CV according to the change of the volume of the cavity CV, and the volume of the cavity CV when the drive signal Com-B supplied to the piezoelectric element PZ[m] indicates the reference potential V0 is larger than the volume of the cavity CV when the drive signal Com-B supplied to the piezoelectric element PZ[m] indicates the potential VB.

Therefore, according to the embodiment, the ejection of the ink from the ejection portion D[m] may be prevented when the ejection portion D[m] is driven by the change from the potential VB to the reference potential V0 in the waveform PB of the drive signal Com-B.

In the inkjet printer 1 according to the embodiment, the time during which the waveform PB changes from the reference potential V0 to the potential VB is longer than the time during which the waveform PB changes from the potential VB to the reference potential V0.

Therefore, according to the embodiment, when the ejection portion D[m] is driven by the change from the potential VB to the reference potential V0 in the waveform PB of the drive signal Com-B, a large vibration can be generated in the ejection portion D[m]. Further, according to the embodiment, the ejection of the ink from the ejection portion D[m] may be prevented when the ejection portion D[m] is driven by the change from the reference potential V0 to the potential VB in the waveform PB of the drive signal Com-B.

In the inkjet printer 1 according to the embodiment, the drive signal Com has the plurality of drive waveforms including the waveform PB, and, in one unit period TP defined by the plurality of pulses PLL, the time length GB from the end of the waveform PB to the end of the one unit period TP is shorter than the time length from the end of all the drive waveforms other than the waveform PB to the end of the one unit period TP.

Therefore, according to the embodiment, compared to a configuration in which the time length GB from the end of the waveform PB to the end of one unit period TP is equal to or longer than the time length from the end of another drive waveform to the end of one unit period TP, the time length from the timing when the driving of the ejection portion D[m] by the waveform PB is ended to the timing when the detection of the vibration remaining in the ejection portion D[m] is started may be shortened, and the vibration remaining in the ejection portion D[m] can be detected more reliably.

### B. Modifications

The above described embodiments can be variously modified. Specific modifications will be exemplified below. Two or more configurations freely selected from the following exemplifications may be appropriately combined in a range in which the configurations are mutually consistent. In the modifications exemplified below, elements having the same actions and functions as those of the embodiment have the same signs referred to in the above description, and the detailed description of the respective elements will be omitted as appropriate.

### Modification 1

In the above described embodiment, as the signal for dividing the unit period TP, the period designation signal Tsig as the signal defining the control period TS2 for detecting the detection potential signal VX[m] from the ejection portion D[m] in the unit period TP is described as an example, however, the present disclosure is not limited to the configuration. The unit period TP may be divided by another signal than the period designation signal Tsig.

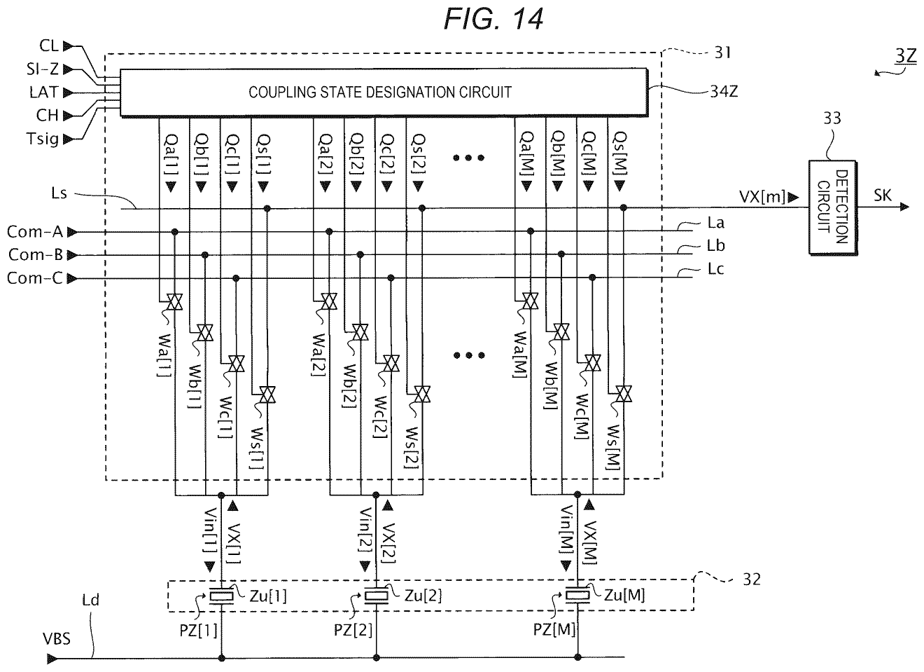

FIG. 14 is a block diagram showing an example of a configuration of a head unit 3Z according to the modification.

As shown in FIG. 14, the head unit 3Z is different from the head unit 3 according to the embodiment in that a coupling state designation circuit 34Z is provided instead of the coupling state designation circuit 34. The coupling state designation circuit 34Z is different from the coupling state designation circuit 34 according to the embodiment in that a change signal CH is supplied and a designation signal SI-Z is supplied instead of the designation signal SI.

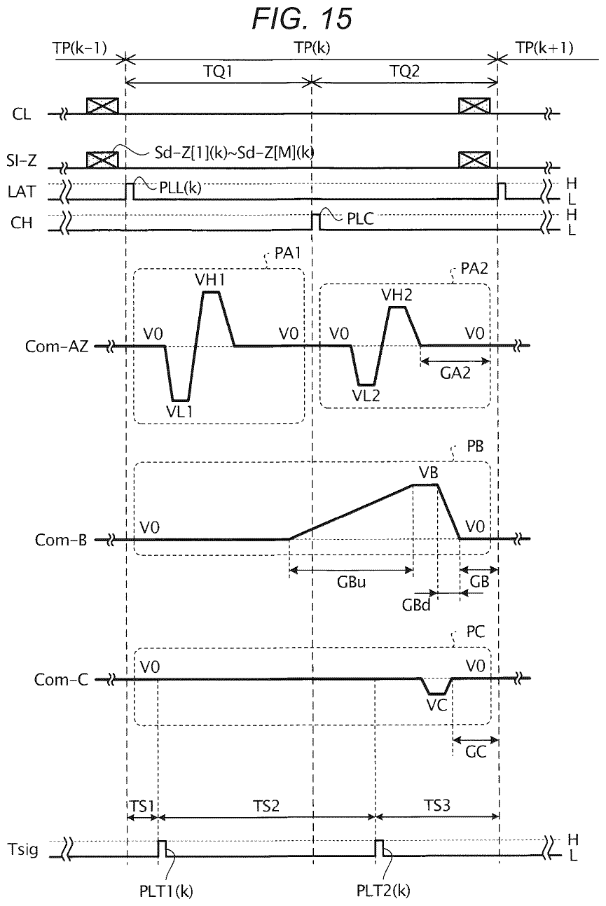

FIG. 15 is a timing chart showing an example of various signals supplied to the head unit 3Z in the modification.

As shown in FIG. 15, in the modification, the head unit 3Z is different from the head unit 3 according to the embodiment in that the change signal CH is supplied, a drive signal Com-Z is supplied instead of the drive signal Com, and a designation signal SI-Z is supplied instead of the designation signal SI.

The change signal CH has a plurality of pulses PLC corresponding to a plurality of unit periods TP. The control unit 2 according to the modification divides the unit period TP(k) into a control period TQ1 from the rise of the pulse PLL(k) to the rise of the pulse PLC and a control period TQ2 from the rise of the pulse PLC to the rise of the pulse PLL(k+1). The pulse PLC is an example of “change pulse”. Hereinafter, the control period TQ1 and the control period TQ2 may be collectively referred to as a control period TQ.

The drive signal Com-Z includes a drive signal Com-AZ, the above described drive signal Com-B, and the above described drive signal Com-C. In the modification, the drive signal Com-Z supplied to the ejection portion D[m] is referred to as a supply drive signal Vin-Z[m]. In the modification, the drive signal Com-Z supplied to the ejection portion D[m] in the unit period TP(k) is referred to as a supply drive signal Vin-Z[m](k).

The drive signal Com-AZ has a waveform PA1 provided in the control period TQ1 and a waveform PA2 provided in the control period TQ2.

As described above, the waveform PA1 is a waveform that returns from the reference potential V0 to the reference potential V0 through the potential VL1 lower than the reference potential V0 and the potential VH1 higher than the reference potential V0. In the modification, the shape of the waveform PA1 is adjusted such that the ink corresponding to an ink amount ξ1 is ejected from the ejection portion D[m] when the supply drive signal Vin-Z[m] having the waveform PA1 is supplied to the ejection portion D[m].

The waveform PA2 is a waveform that returns from the reference potential V0 to the reference potential V0 through a potential VL2 lower than the reference potential V0 and a potential VH2 higher than the reference potential V0. In the modification, the shape of the waveform PA2 is adjusted such that the ink corresponding to an ink amount ξ2 is ejected from the ejection portion D[m] when the supply drive signal Vin-Z[m] having the waveform PA2 is supplied to the ejection portion D[m].

Hereinafter, a waveform including the waveform PA1 and the waveform PA2 of the drive signal Com-AZ in each unit period TP may be referred to as a waveform PA.

Here, the ink amount ξ1 is an ink amount corresponding to a medium dot Dt2. The ink amount ξ2 is an ink amount that is smaller than the ink amount ξ1 and corresponds to a small dot Dt3 smaller than the medium dot Dt2. The total amount of the ink amount ξ1 and the ink amount ξ2 is an ink amount corresponding to a large dot Dt1 larger than the medium dot Dt2. In the inkjet printer 1 according to the modification, each ejection portion D[m] can form any one dot Dt of the three types of dots Dt of the large dot Dt1, the medium dot Dt2, and the small dot Dt3 in each unit period TP. Therefore, according to the inkjet printer 1 of the modification, a high-definition image may be formed compared to a configuration in which each ejection portion D[m] can form only one type of dot Dt in each unit period TP.

In the modification, the waveform PA2 is arranged such that a time length GA2 from the end of the waveform PA2 to the end of the unit period TP in which the waveform PA2 is provided is longer than the time length GB.

The control unit 2 according to the modification supplies the designation signal SI-Z to the coupling state designation circuit 34Z in synchronization with the clock signal CL prior to each unit period TP. Here, the designation signal SI-Z includes M individual designation signals Sd-Z[1] to Sd-Z[M] corresponding to the M ejection portions D[1] to D[M] on a one-to-one basis. Of the signals, the individual designation signal Sd-Z[m] designates a drive mode of the ejection portion D[m] in the unit period TP.

Specifically, in the modification, the individual designation signal Sd-Z[m] can take any one of six values of a value “1” designating the ejection portion D[m] as a large dot forming ejection portion DP1, a value “2” designating the ejection portion D[m] as a medium dot forming ejection portion DP2, a value “3” designating the ejection portion D[m] as a small dot forming ejection portion DP3, a value “4” designating the ejection portion D[m] as the dot non-forming ejection portion DN, a value “5” designating the ejection portion D[m] as the check drive ejection portion DS1, and a value “6” designating the ejection portion D[m] as the vibration detection ejection portion DS2 in each unit period TP. Here, the large dot forming ejection portion DP1 is an ejection portion D that ejects the ink in the total amount of the ink amount ξ1 and the ink amount 82 from the nozzle N in the unit period TP to form the large dot Dt1 on the recording paper PP. The medium dot forming ejection portion DP2 is an ejection portion D that ejects the ink in the ink amount ξ1 from the nozzle N in the unit period TP to form the medium dot Dt2 on the recording paper PP. The small dot forming ejection portion DP3 is an ejection portion D that ejects the ink in the ink amount ξ2 from the nozzle N in the unit period TP to form the small dot Dt3 on the recording paper PP.

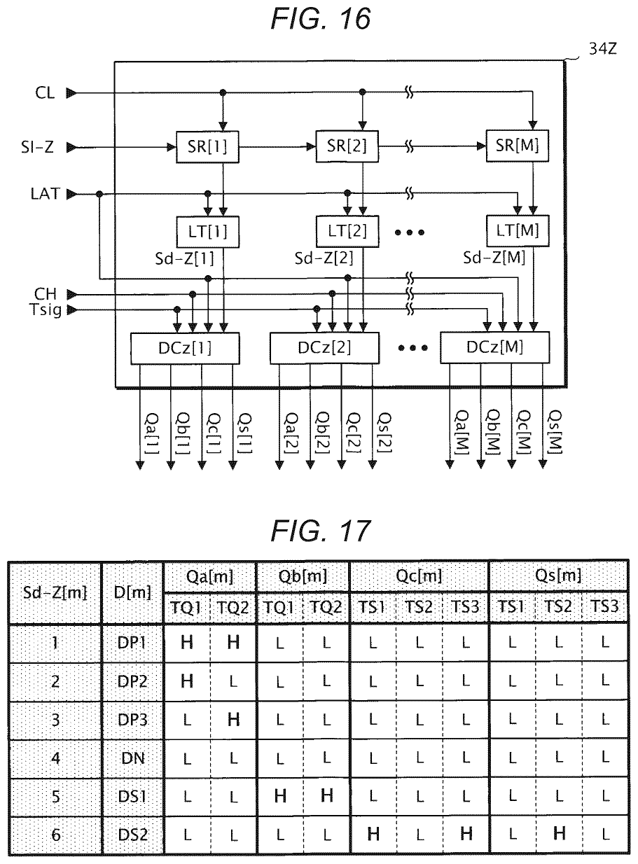

FIG. 16 is a block diagram showing an example of a configuration of the coupling state designation circuit 34Z.

As shown in FIG. 16, the coupling state designation circuit 34Z is different from the coupling state designation circuit 34 according to the embodiment in that M decoders DCz[1] to DCz[M] are provided instead of the M decoders DC[1] to DC[M]. The individual designation signals Sd-Z[1] to Sd-Z[M] are serially supplied to the transfer circuit SR[1]. Then, the individual designation signal Sd-Z[m] supplied to the transfer circuit SR[1] is sequentially transferred from the transfer circuit SR[1] to the transfer circuit SR[m] by the m transfer circuits SR[1] to SR[m] of the M transfer circuits SR[1] to SR[M] in synchronization with the clock signal CL. The latch circuit LT[m] latches the individual designation signal Sd-Z[m] supplied to the transfer circuit SR[m] at a timing when the pulse PLL of the latch signal LAT rises to a high level. The decoder DCz[m] generates the coupling state designation signal Qa[m], the coupling state designation signal Qb[m], the coupling state designation signal Qc[m], and the coupling state designation signal Qs[m] based on the individual designation signal Sd-Z[m], the change signal CH, the latch signal LAT, and the period designation signal Tsig.

FIG. 17 is an explanatory diagram showing an example of the operation of the decoder DCz[m] according to the modification.

As shown in FIG. 17, when the individual designation signal Sd-Z[m] indicates the value “1” that designates the ejection portion D[m] as the large dot forming ejection portion DP1 in the unit period TP, the decoder DCz[m] sets the coupling state designation signal Qa[m] at the high level over the unit period TP. In this case, the ejection portion D[m] is driven by the supply drive signal Vin[m] having the waveform PA1 and the waveform PA2, and ejects the ink in the total amount of the ink amount ξ1 and the ink amount ξ2 to form the large dot Dt1.

When the individual designation signal Sd-Z[m] indicates the value “2” that designates the ejection portion D[m] as the medium dot forming ejection portion DP2 in the unit period TP, the decoder DCz[m] sets the coupling state designation signal Qa[m] at the high level in the control period TQ1. In this case, the ejection portion D[m] is driven by the supply drive signal Vin[m] having the waveform PA1, and ejects the ink in the ink amount ξ1 to form the medium dot Dt2.

When the individual designation signal Sd-Z[m] indicates the value “3” that designates the ejection portion D[m] as the small dot forming ejection portion DP3 in the unit period TP, the decoder DCz[m] sets the coupling state designation signal Qa[m] at the high level in the control period TQ2. In this case, the ejection portion D[m] is driven by the supply drive signal Vin[m] having the waveform PA2, and ejects the ink in the ink amount ξ2 to form the small dot Dt3.

When the individual designation signal Sd-Z[m] designates the ejection portion D[m] as the dot non-forming ejection portion DN, designates the ejection portion D[m] as the check drive ejection portion DS1, and designates the ejection portion D[m] as the vibration detection ejection portion DS2 in the unit period TP, the ejection portion D[m] operates in the same manner as in the above described embodiment.

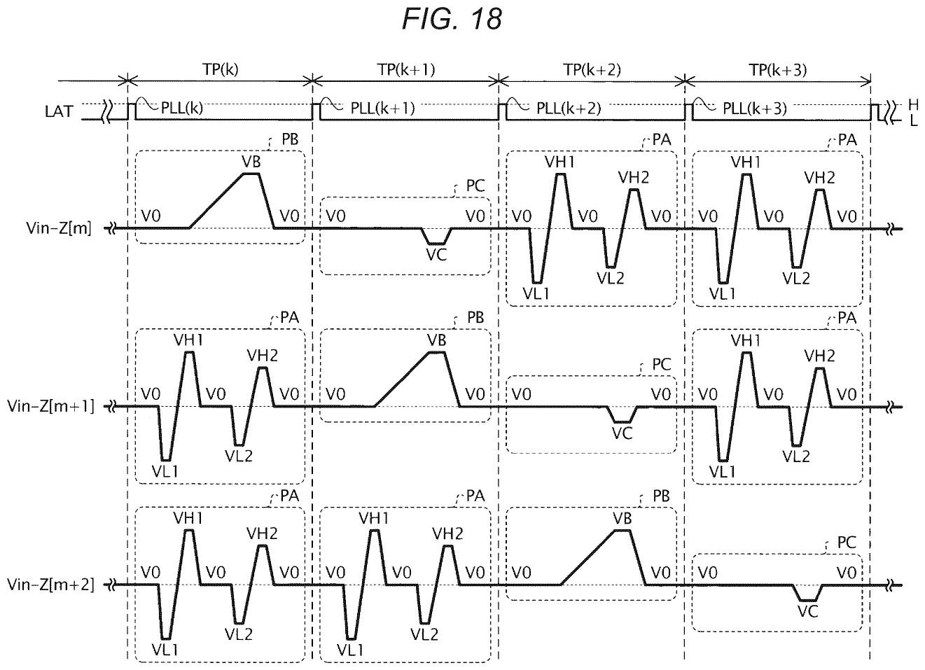

FIG. 18 is a timing chart showing an example of the supply drive signals Vin-Z[m] to Vin-Z[m+2] supplied to the plurality of ejection portions D[m] to D[m+2] provided in the head unit 32 in the plurality of unit periods TP(k) to TP(k+3).

In FIG. 18, a case where the variable m is a natural number satisfying “1≤m≤M−2” is assumed. Hereinafter, the individual designation signal Sd-Z[m] designating the operation of the ejection portion D[m] in the unit period TP(k) is referred to as an individual designation signal Sd-Z[m](k).

In FIG. 18, a case where, in the four unit periods TP of the unit period TP(k), the unit period TP(k+1), the unit period TP(k+2), and the unit period TP(k+3), the ejection state check processing at three times for three ejection portions D of the ejection portion D[m], the ejection portion D[m+1], and the ejection portion D[m+2] is executed is assumed. Further, in FIG. 18, a case where, of the three ejection portions D of the ejection portion D[m], the ejection portion D[m+1], and the ejection portion D[m+2], the ejection portion D which is not an object of the ejection state check processing is driven as the large dot forming ejection portion DP1 is assumed.

The control unit 2 according to the modification generates the individual designation signal Sd-Z[m](k) designating the ejection portion D[m] as the check drive ejection portion DS1 in the unit period TP(k), and generates the individual designation signal Sd-Z[m](k+1) designating the ejection portion D[m] as the vibration detection ejection portion DS2 in the unit period TP(k+1). Thereby, as shown in FIG. 18, the inkjet printer 1 according to the modification supplies the drive signal Com-B having the waveform PB as the supply drive signal Vin-Z[m](k) to the ejection portion D[m] in the unit period TP(k), and supplies the drive signal Com-C having the waveform PC as the supply drive signal Vin-Z[m](k+1) to the ejection portion D[m] in the unit period TP(k+1). As a result, the inkjet printer 1 according to the present modification executes the check object drive processing for the ejection portion D[m] in the unit period TP(k), and then, executes the residual vibration detection processing for the ejection portion D[m] in the unit period TP(k+1). The inkjet printer 1 according to the modification executes the ejection state check processing for the ejection portion D[m+1] by executing the check object drive processing for the ejection portion D[m+1] in the unit period TP(k+1), and then, executing the residual vibration detection processing for the ejection portion D[m+1] in the unit period TP(k+2). The inkjet printer 1 according to the modification executes the ejection state check processing for the ejection portion D[m+2] by executing the check object drive processing for the ejection portion D[m+2] in the unit period TP(k+2), and then, executing the residual vibration detection processing for the ejection portion D[m+2] in the unit period TP(k+3).

As described above, the inkjet printer according to the modification includes the ejection portion D[m] that ejects the ink according to supply of the drive signal Com-Z, the supply circuit 31 that supplies the drive signal Com-Z to the ejection portion D[m], and the detection circuit 33 that detects the vibration in the ejection portion D[m]. The supply circuit 31 supplies the drive signal Com-B having the waveform PB of the drive signal Com-Z to the ejection portion D[m] in the unit period TP(k) started by the pulse PLL(k) of the plurality of pulses PLL contained in the latch signal LAT supplied to the supply circuit 31 and ended by the pulse PLL(k+1) provided next to the pulse PLL(k) of the plurality of pulses PLL, and the detection circuit 33 detects the vibration remaining in the ejection portion D[m] in the unit period TP(k+1) started by the pulse PLL(k+1) and ended by the pulse PLL(k+2) provided next to the pulse PLL(k+1) of the plurality of pulses PLL, and the supply circuit 31 is supplied with the designation signal SI-Z designating whether to eject the ink from the ejection portion D[m] in each of the plurality of unit periods TP at the timing corresponding to each of the plurality of unit periods TP defined by the plurality of pulses PLL, and is supplied with the change signal CH having the plurality of pulses PLC for dividing each of a plurality of unit periods TP into the plurality of control periods TQ, and the designation signal SI-Z supplied to the supply circuit 31 at the timing corresponding to one unit period TP of the plurality of unit periods TP designates whether there is the ink from the ejection portion D[m] in each of the plurality of control periods TQ forming the one unit period TP, and the supply circuit 31 supplies the drive signal Com-Z to the ejection portion D[m] based on the designation signal SI-Z supplied to the supply circuit 31 at the timing corresponding to the one unit period TP in each of the plurality of control periods TO forming the one unit period TP.

As described above, according to the modification, since the ejection portion D[m] is driven in one unit period TP and the vibration is detected from the ejection portion D[m] in another unit period TP subsequent to the one unit period TP, and thereby, the time length of the unit period TP can be shortened compared to a configuration in which both driving of the ejection portion D[m] and detection of the vibration from the ejection portion D[m] are performed in one unit period TP. Thereby, according to the modification, the printing processing of forming an image on the recording paper PP by ejecting the ink from the ejection portion D[m] can be made faster.

### Modification 2

In the above described embodiment and Modification 1, the case where the check unit 5 is provided separately from the head unit 3 is described as an example, however, the present disclosure is not limited to the configuration. The check unit 5 may be provided in the head unit 3. In this case, compared to a configuration in which the check unit 5 is provided outside the head unit 3, the chance that noise is mixed in the detection signal SK[m] supplied to the check unit 5 by the detection circuit 33 may be suppressed, and the accuracy of the check in the check unit 5 may be increased.

### Modification 3

In the above described embodiment and Modifications 1 and 2, the case where the inkjet printer 1 includes the four head units 3 is assumed, however, the present disclosure is not limited to the configuration. The inkjet printer 1 may include one to three head units 3, or may include five or more head units 3.

### Modification 4

In the above described embodiment and Modifications 1 to 3, the case where the inkjet printer 1 is a serial printer is exemplified, however, the present disclosure is not limited to the configuration. The inkjet printer 1 may be a so-called line printer in which a plurality of nozzles N are provided to extend to be wider than the width of the recording paper PP in the head unit 3.

What is claimed is:

1. A liquid ejection head comprising:
an ejection portion ejecting a liquid in response to supply of a drive signal;
a supply unit supplying the drive signal to the ejection portion; and
a detection unit detecting a vibration in the ejection portion, wherein
the supply unit supplies a check drive signal having a check waveform of the drive signal to the ejection portion in a first unit period started by a first latch pulse of a plurality of latch pulses contained in a latch signal supplied to the supply unit and ended by a second latch pulse provided next to the first latch pulse of the plurality of latch pulses, and
the detection unit detects a vibration remaining in the ejection portion in a second unit period started by the second latch pulse and ended by a third latch pulse provided next to the second latch pulse of the plurality of latch pulses.

2. The liquid ejection head according to claim 1, wherein,
at a timing corresponding to each of a plurality of unit periods defined by the plurality of latch pulses, the supply unit is supplied with a designation signal for designating whether to eject the liquid from the ejection portion in each of the plurality of unit periods, and
the supply unit supplies the drive signal to the ejection portion based on the designation signal in each of the plurality of unit periods.

3. The liquid ejection head according to claim 2, wherein
the supply unit is supplied with a change signal having a plurality of change pulses for dividing each of the plurality of unit periods into a plurality of control periods,
a designation signal supplied to the supply unit at a timing corresponding to one unit period of the plurality of unit periods designates whether to eject the liquid from the ejection portion in each of the plurality of control periods forming the one unit period, and
the supply unit supplies the drive signal to the ejection portion based on the designation signal supplied to the supply unit at the timing corresponding to the one unit period in each of the plurality of control periods forming the one unit period.

4. The liquid ejection head according to claim 1, wherein
the detection unit detects the vibration remaining in the ejection portion in a detection period started by a detection start pulse contained in a period designation signal supplied to the supply unit and ended by a detection end pulse contained in the period designation signal in the second unit period.

5. The liquid ejection head according to claim 4, wherein
the drive signal includes a detection drive signal supplied to the ejection portion in at least a part of the second unit period,
the check drive signal indicates a first potential at a timing when the second latch pulse is supplied to the supply unit, and
the detection drive signal maintains the first potential in at least a period from the timing when the second latch pulse is supplied to the supply unit to a timing when the detection period is started in the second unit period.

6. The liquid ejection head according to claim 5, wherein
the check waveform is a waveform that changes from the first potential to a second potential, and then, changes from the second potential to the first potential.

7. The liquid ejection head according to claim 6, wherein
the ejection portion includes
a piezoelectric element driven by the drive signal,
a pressure chamber filled with a liquid and having a volume that changes according to driving of the piezoelectric element, and
a nozzle ejecting the liquid in the pressure chamber according to the change of the volume of the pressure chamber, and
the volume of the pressure chamber when the drive signal supplied to the piezoelectric element indicates the first potential is larger than the volume of the pressure chamber when the drive signal supplied to the piezoelectric element indicates the second potential.

8. The liquid ejection head according to claim 7, wherein
a time during which the check waveform changes from the first potential to the second potential is longer than a time during which the check waveform changes from the second potential to the first potential.

9. The liquid ejection head according to claim 1, wherein
the drive signal has a plurality of drive waveforms including the check waveform, and
in one unit period defined by the plurality of latch pulses, a time length from an end of the check waveform to an end of the one unit period is shorter than a time length from an end of all drive waveforms other than the check waveform of the plurality of drive waveforms to an end of the one unit period.

10. A liquid ejection apparatus comprising:
an ejection portion ejecting a liquid in response to supply of a drive signal;
a supply unit supplying the drive signal to the ejection portion; and
a detection unit detecting a vibration in the ejection portion, wherein
the supply unit supplies a check drive signal having a check waveform of the drive signal to the ejection portion in a first unit period started by a first latch pulse of a plurality of latch pulses contained in a latch signal supplied to the supply unit and ended by a second latch pulse provided next to the first latch pulse of the plurality of latch pulses, and
the detection unit detects a vibration remaining in the ejection portion in a second unit period started by the second latch pulse and ended by a third latch pulse provided next to the second latch pulse of the plurality of latch pulses.

11. A method of controlling a liquid ejection head including an ejection portion that ejects a liquid in response to supply of a drive signal, a supply unit that supplies the drive signal to the ejection portion, and a detection unit that detects a vibration in the ejection portion, the method comprising:
controlling the liquid ejection head to supply a check drive signal having a check waveform of the drive signal to the ejection portion by the supply unit in a first unit period started by a first latch pulse of a plurality of latch pulses contained in a latch signal supplied to the supply unit and ended by a second latch pulse provided next to the first latch pulse of the plurality of latch pulses; and
controlling the liquid ejection head to detect a vibration remaining in the ejection portion by the detection unit in a second unit period started by the second latch pulse and ended by a third latch pulse provided next to the second latch pulse of the plurality of latch pulses.

12. The method according to claim 11, wherein
the liquid ejection head is controlled, at a timing corresponding to each of a plurality of unit periods defined by the plurality of latch pulses,
to supply a designation signal for designating whether to eject the liquid from the ejection portion in each of the plurality of unit periods to the supply unit, and
to supply the drive signal to the ejection portion by the supply unit based on the designation signal in each of the plurality of unit periods.

13. The method according to claim 12, wherein
the liquid ejection head is controlled to
supply a change signal having a plurality of change pulses for dividing each of the plurality of unit periods into a plurality of control periods to the supply unit,
designate whether to eject the liquid from the ejection portion by a designation signal supplied to the supply unit at a timing corresponding to one unit period of the plurality of unit periods in each of the plurality of control periods forming the one unit period, and
supply the drive signal to the ejection portion by the supply unit based on the designation signal supplied to the supply unit at the timing corresponding to the one unit period in each of the plurality of control periods forming the one unit period.

14. The method according to claim 11, wherein
the liquid ejection head is controlled to
detect the vibration remaining in the ejection portion by the detection unit in a detection period started by a detection start pulse contained in a period designation signal supplied to the supply unit and ended by a detection end pulse contained in the period designation signal in the second unit period.

15. The method according to claim 14, wherein
the drive signal includes a detection drive signal supplied to the ejection portion in at least a part of the second unit period,
the check drive signal indicates a first potential at a timing when the second latch pulse is supplied to the supply unit, and
the detection drive signal maintains the first potential in at least a period from the timing when the second latch pulse is supplied to the supply unit to a timing when the detection period is started in the second unit period.

16. The method according to claim 15, wherein
the check waveform is a waveform that changes from the first potential to a second potential, and then, changes from the second potential to the first potential.

17. The method according to claim 16, wherein
the ejection portion includes
a piezoelectric element driven by the drive signal,
a pressure chamber filled with a liquid and having a volume that changes according to driving of the piezoelectric element, and
a nozzle ejecting the liquid in the pressure chamber according to the change of the volume of the pressure chamber, and
a volume of the pressure chamber when the drive signal supplied to the piezoelectric element indicates the first potential is larger than a volume of the pressure chamber when the drive signal supplied to the piezoelectric element indicates the second potential.

18. The method according to claim 17, wherein
a time during which the check waveform changes from the first potential to the second potential is longer than a time during which the check waveform changes from the second potential to the first potential.

19. The method according to claim 11, wherein
the drive signal has a plurality of drive waveforms including the check waveform, and
in one unit period defined by the plurality of latch pulses, a time length from an end of the check waveform to an end of the one unit period is shorter than a time length from an end of all drive waveforms other than the check waveform of the plurality of drive waveforms to an end of the one unit period.
